(19) United States
(12) Patent Application Publication
(10) Pub. No.: US 2010/0264008 A1
(43) Pub. Date: Oct. 21, 2010

(54) STANDBY POWER CUT-OFF SWITCH

(76) Inventor: Byong Ho Kim, Busan (KR)

Correspondence Address: PARK LAW FIRM, 3255 WILSHIRE BLVD, SUITE 1110, LOS ANGELES, CA, 90010, US

(21) Appl. No.: 12/741,255

(22) PCT Filed: Nov. 18, 2008
(86) PCT No.: PCT/KR2008/006795

§ 371 Date: May 4, 2010

(30) Foreign Application Priority Data
Nov. 20, 2007 (KR) 10-2007-0118585
Mar. 13, 2008 (KR) 10-2008-0023479
Nov. 13, 2008 (KR) 10-2008-0112709

(51) Int. Cl. H01H 3/02

(52) U.S. Cl. 200/52 R

(57) ABSTRACT

The present invention provides a standby power cut-off switch which is directly installed in electric products such as TV sets, audio systems, computers, etc., so that even when a power plug is connected to an electrical outlet, supply of an external power to the electric products through the plug is completely interrupted (i.e., double pole interruption) mechanically by means of an automatically controlled OFF signal so as to prevent the consumption of standby power, and in which a first input terminal and a first output terminal are first electrically connected to each other and then a second input terminal and a second output terminal are electrically connected to each other so that a double-pole switch eventually functions as a single-pole switch so as to allow an electrical contact between terminals to be made sequentially, thereby preventing a spark and an electrical shock to the electric product that may occur when the two poles of the switch concurrently come into close contact with a main body of the electric product during the powering on of the electric products.

### TECHNICAL FIELD

The present invention relates to a standby power cut-off switch, and more particularly, to such a standby power cut-off switch which is directly installed in electric products such as TV sets, audio systems, computers, etc., so that even when a power plug is connected to an electrical outlet, supply of an external power to the electric products through the plug is completely interrupted (i.e., double pole interruption) mechanically by means of an automatically controlled OFF signal so as to prevent the consumption of standby power, and in which a first input terminal and a first output terminal are first electrically connected to each other and then a second input terminal and a second output terminal are electrically connected to each other so that a double-pole switch eventually functions as a single-pole switch so as to allow an electrical contact between terminals to be made sequentially, thereby preventing a spark and an electrical shock to the electric product that may occur when the two poles of the switch concurrently come into close contact with a main body of the electric product during the powering on of the electric products.

### BACKGROUND ART

The products (hereinafter, referred to as “electric products” such as generally used electric household appliances, office equipment, industrial equipment and the like are operated by receiving power applied from an external power source through an electrical switch. Also, the power to be applied to the inside of the electric products through the switch is supplied to the electric products by means of an electrical plug installed in the electric products. In this case, the electrical plug may be of a type which is coupled integrally with the electric products or is electrically connected to the electric products through a connection terminal of the electric products. Such an electrical plug is connected to an electrical outlet mounted to the wall surface inside a building.

Even in the case where the electric products whose plug is connected to the electrical outlet are not used, power consumption occurs at a slight level due to a contact resistance. In addition, electric power is consumed while a state being maintained where a standby current flows inside the electric products in order to maintain a basic state where a response can be made to any instruction. For example, a power switch of a PC actually is a switch for applying on ON/OFF signal to a control circuit, but not a switch for supplying power and interrupting the supply of power. In case of the TV set, even when no picture appears on the TV screen for the purpose of responding to a signal outputted from a remote controller, a standby current is required so as to receive the signal from the remote controller through the connection of an electrical plug connected to the TV set to an electrical receptacle. Further, the standby power is widely used in our daily life along with convenience of life owing to an auxiliary function (e.g. time display), but not a main function of the electric products. Since the amount of the standby current used is large and power consumption is also great accordingly, the government promotes that the plug of the electric products should be removed from the electric outlet or the supply of the standby power should be interrupted using an auxiliary switch device such as a multitap. Meanwhile, any electric product interrupts the supply of the power by manually turning the power supply on/off using a switch, i.e., a single-pole switch installed in the electric product itself in a state where the plug of the electric product has been always connected to the electrical outlet. Such a single-pole switch of actually interrupting the supply of the power does not allow the standby current to flow inside the electric product, but may cause a slight amount of power to leak and is inferior to the double-pole switching in securing stability of electricity use.

Korean Patent Registration No. 10-0299760 has proposed an energy-saving standby power control apparatus and method in which power is supplied to a standby power circuit only in the time zone which is set manually by a user, the time zone obtained by statistically analyzing the time zone when the user utilizes the electric appliance, or the time zone when the electric appliance is likely to be used on dependence of the use characteristics of the electric appliance, and the supply of the power to the standby power circuit is interrupted in the time zone except the above-mentioned time zone, such that a microcomputer sets the time during which the standby power will be supplied based on information regarding the aforementioned time zone and transmits the set standby power-supply time information to a standby power control section including a timer mounted therein. In this case, the standby power control section sets the time for the standby power to be supplied in the timer so that it controls the standby power to be interrupted before the set time and the standby power to be automatically supplied after the lapse of the set time, thereby reducing power waste in a standby power state.

Korean Utility Model Laid-Open Publication No. 2000-0015102 has proposed an apparatus for reducing power consumption in the standby power state, in which an output voltage of a standby power circuit which converts AC power outputted from a power plug into DC power is supplied to only a microcomputer, so that an output voltage of a standby power circuit is set to be relatively low as compared to a conventional prior art, and which includes a photo triac so that the microcomputer determines whether or not to supply a main power to the electric appliance using the photo triac, thereby reducing the number of components for determining whether or not to apply AC power to a main power circuit and simultaneously saving the power consumption of the standby power.

Korean Patent Laid-Open Publication No. 10-2006-0008699 has proposed a standby power saving push switch structure in which a push switch installed in a power supply applying main power to each part of an electronic appliance system so as to turn the main power on/off, a button releasing section installed in the push switch so as to release a button of the push switch to turn the main power off, and a microcomputer for counting the time after the entry into a standby mode and applying an electrical signal to the button releasing section when a predetermined time is lapsed so as to control the button releasing section to release the button of the push switch, thereby preventing the power consumption occurring during the standby mode of the electronic appliance.

Such conventional prior arts propose a control method and apparatus for reducing the standby power. However, they encounter a problem in that they cannot fundamentally interrupt the standby power inside electric products as being merely technologies for basically preserving the standby power, i.e., power for maintaining the operation of the microcomputer and the like.

In the meantime, Korean Utility Model Registration No. 20-0255382 has proposed a an electrical outlet mounting structure for interrupting the standby power, in which a first outlet terminal connected to a first withdrawal line and a second withdrawal line is separated from a second outlet terminal connected to a third withdrawal line and a fourth withdrawal line, and a non-withdrawal line is connected to the first outlet terminal or the second outlet terminal in such a fashion that the first withdrawal line is connected with an auxiliary main line that is connected to a first main line and a switch capable of turning the power on/off, the second withdrawal line is connected to a second main line, and the third withdrawal line and the fourth withdrawal line are connected to the first main line and the second main line, thereby interrupting the standby power which is not in use through the short-circuiting of the switch by the first outlet terminal.

However, such a conventional prior art is similar to a method of using an auxiliary switch called a circuit breaker or a multitap as being merely a technology for installing a separate auxiliary switch at an intermediate portion. That is, this conventional prior art has an inconvenience in that a single-pole switch or a double-pole switch for intentionally interrupting the standby power such as an auxiliary switch or the multitap must be installed and manually operated in order for a user to interrupt the standby power in a similar way that user remove the plug from the outlet when the electric product is not in use, i.e., during the turning off of the power. In addition, the above double-pole switch entails problems in that when the electric product is connected to a power supply in a state where it is turned on, a spark may occur substantially, and a shock may be applied to an electric or electronic circuit of the electric product, giving a damage to it.

### DISCLOSURE

### Technical Problem

Accordingly, the present invention has been made in an effort to solve the above problem occurring in the prior art, and it is an object of the present invention to provide a new type of standby power cut-off switch which is directly installed in an electric product, so that even when a power plug is connected to an electrical outlet, supply of an external power to the electric product through the plug is completely interrupted (i.e., double pole interruption) mechanically by means of an automatically controlled OFF signal so as to conveniently eliminate the standby power (a slight amount of power) as if the plug were removed from the outlet.

Another object of the present invention is to provide a new type of standby power cut-off switch which includes an input terminal block having a first input terminal and a second input terminal, and an opening/closing unit having a first opening/closing terminal and a second opening/closing terminal, so that the first input terminal and the second input terminal of the input terminal block are concurrently separated from the first opening/closing terminal and the second opening/closing terminal of the opening/closing unit at the time of turning the power off to cause the first and second input terminals and the first and second opening/closing terminals to be opened, thereby eliminate the standby power.

In the meantime, in order to overcome a problem in that in case where the second input terminal and the first input terminal of the input terminal block are simultaneously brought into close contact with the second opening/closing terminal and the first opening/closing terminal upon the application of power to an electric product, a large spark may occur between the terminals in close contact with each other and an internal circuit of the electric product may be damaged or broken due to an electric shock, the first terminals are connected to each other and then the second terminals are connected to each other to allow the power to be supplied to an “OFF” control circuit and a main body of the electric product.

In other words, the present invention is aimed to provide a new type of standby power cut-off switch which is installed in an electric product, so that supply of an external power to the electric product through the plug is completely interrupted (i.e., double pole interruption) mechanically by means of a manual or automatic control manner during the powering off of the electric product as to eliminate the standby power (a slight amount of power), and in which a double-pole switch eventually functions as a single-pole switch so as to allow an electrical contact between terminals to be made sequentially, thereby preventing a fire due to a large spark that may occur at the double-pole switch and an electric shock of the electric product during the powering on of the electric product.

### Technical Solution

To accomplish the above object, according to the present invention, there is provided a standby power cut-off switch adapted to be installed in an electric product for completely interrupting supply of an external power to the electric product through a power plug 1, the standby power cut-off switch comprising: a housing 12 securely fixed to the electric product; an input terminal block 20 including a second input terminal 24 which is connected to a second electric wire 3 of the plug 1 in the housing 12 and a first input terminal 22 which is connected to a first electric wire 2 of the plug 1 in the housing 12; an opening/closing unit 40 disposed in the housing 12, the opening/closing unit including a second opening/closing terminal 44 adapted to be brought into close contact with the second input terminal 24 and a first opening/closing terminal 42 adapted to brought into close contact with the first input terminal 22, so that the second opening/closing terminal 44 and the first opening/closing terminal 42 are brought into close contact with and are separated from the second input terminal 24 and the first input terminal 22, respectively; an ON button slidably coupled to the housing 12 so that when a user presses the On button, the opening/closing unit 40 is operated to cause the second opening/closing terminal 44 and the first opening/closing terminal 42 to be brought into close contact with the second input terminal 24 and the first input terminal 22, respectively, and then the ON button returns to its original position; an output terminal block 100 including a second output terminal 104 which is connected to a second electric wire 7 of an internal power supply line 5 extending to the inside of the electric product in such a fashion as to be electrically connected to the second opening/closing terminal 44 of the opening/closing unit 40 within the housing, and a first output terminal 102 which is connected to a first electric wire 6 of the internal power supply line 5 extending to the inside of the electric product in such a fashion as to be electrically connected to the first opening/closing terminal 42 of the opening/closing unit 40 within the housing; an OFF unit 110 disposed in the housing, the OFF unit being adapted to operate the opening/closing unit 40 in a state where the second opening/closing terminal 44 and the first opening/closing terminal 42 of the opening/closing unit 40 are in close contact with the second input terminal 24 and the first input terminal 22, respectively, so that the second opening/closing terminal 44 and the first opening/closing terminal 42 are simultaneously separated from the second input terminal 24 and the first input terminal 22, respectively; and a delay unit 80 disposed between the second input terminal 24 and the second output terminal 104, the delay unit being configured such that the delay unit is operated earlier than the opening/closing unit 40 upon the depression of the ON button 14, thereby preventing the second input terminal 24 and the second output terminal 104 from being electrically connected to each other despite the operation of the opening/closing unit 40, and such that when the opening/closing unit 40 is operated by the pushing of the ON button 14 to cause the first input terminal 22 and the first output terminal 102 to be electrically connected to each other and then the ON button 14 returns to its original position, the second input terminal 24 and the second output terminal 104 are electrically connected to each other, so that the first output terminal 102 and the second output terminal 104 are sequentially connected to the internal power supply line 5 with a time difference.

In the standby power cut-off switch according to the present invention, the second input terminal 24 and the first input terminal 22 of the input terminal block 20 are arranged perpendicularly to a sliding direction of the ON button 14, and the second opening/closing terminal 44 and the first opening/closing terminal 42 of the opening/closing unit 40 are arranged perpendicularly to the sliding direction of the ON button 14 in such a fashion that one end of the second opening/closing terminal 44 is fixed so as to be electrically connected to the second output terminal 104 and the other end of the second opening/closing terminal 44 is spaced apart from the second input terminal 24 at a position corresponding to the second input terminal 24 so as to be elastically movable to be brought into close contact with and separated (opened) from the second input terminal 24, and the one end of the first opening/closing terminal 42 is fixed so as to be electrically connected to the first output terminal 102 and the other end of the first opening/closing terminal 42 is spaced apart from the first input terminal 22 at a position corresponding to the first input terminal 22 so as to be elastically movable to be brought into close contact with and separated (opened) from the first input, terminal wherein the opening/closing unit 40 includes: a supporting barrel 50 having a hollow portion 53 opened at front and rear ends thereof and supportedly fixed to the housing 12 in such a fashion that the hollow portion 53 thereof is arranged in parallel with a sliding direction of the ON button 14, the hollow portion 53 having a first aperture 54 and a second aperture 56 formed penetratingly on the outer circumference thereof in such a fashion as to be arranged in parallel with each other; a locking bar 60 including a main rod 62 and a sub-rod 64 branched off from the main rod 62 so as to be elastically moved, so that the main rod and the sub-rod are slidably coupled to the hollow portion 53 of the supporting barrel 50 in a direction where the ON button is oriented, the sub-rod having a first stopper 66 and a second stopper 68 protrudingly formed on the top surface thereof so that when the locking bar 60 is coupled to the supporting barrel 50, the first stopper 66 and the second stopper 68 engage with the first aperture 54 and the second aperture 56, respectively, and when the ON button button 14 is pushed, the first stopper 66 and the second stopper 68 engage with the second aperture 56 together so as to be held in position; and a pressing bar 70 including a column 72 and a loader 74 extending outwardly from one side of the column 72 in such a fashion as to be oriented perpendicular to the column 72 so as to press one sides of the second opening/closing terminal 44 and the first opening/closing terminal 42 with a uniform force, the pressing bar 70 being sildably coupled at one end thereof to the hollow portion 53 of the supporting barrel 50 so as to be opposed to the locking bar 60 and being supported at the other end thereof by a spring 78 supportedly mounted to the housing 12, wherein the supporting barrel 50 includes a release piece 58 hingeably mounted on the outer circumferential surface of the hollow portion so as to be positioned adjacent to the second aperture 56, the release piece 58 having a spring mounted therein so that the release piece 58 presses the second stopper 68 of the first and second stoppers 66 and 68 engagedly retained in the second aperture 56 to retract the locking bar 60 to cause the first stopper 66 of the sub-rod 64 to be engagedly retained in the first aperture 54, and then rotates hingeably so as to return to its original position, wherein the delay unit includes a first delay bracket 81a disposed between the supporting barrel 50 and the ON button 14 in such a fashion as to be oriented horizontal to the sliding direction of the ON button 14, a support block 90 disposed between the first delay bracket 81a and the supporting barrel 50 in such a fashion as to be securely fixed to the housing 12, and a second delay bracket 81b joined to the top end of the support block 90 so as to abut against the first delay bracket 81a and electrically connected to the second output terminal 104, and wherein the first delay bracket 81a is fixed to the housing 12 and connected to the second opening/closing terminal 44 by an electric wire at one end thereof and is brought in close contact with the second delay bracket 81b at the other end thereof so that the other end of the first delay bracket 81a is pressed and elastically moved upon the pushing of the ON button 14 so as to be separated from the second delay bracket 81b, whereby when the ON button 14 is pushed and slidably advances, the first delay bracket 81a and the second delay bracket 81b in close contact with each other are first separated from each other, and the opening/closing unit 40 is operated in a state where the second output terminal 104 and the second input terminal 24 are separated from each other to cause the second opening/closing terminal 44 and the first opening/closing terminal 42 to be brought into close contact with the second input terminal 24 and the first input terminal 22, respectively, so as to electrically interconnect the first output terminal 102 and the first input terminal 22, and then when the ON button 14 slidably retracts in an opposite direction to the sliding direction thereof so as to return to its original position, the first delay bracket 81a and the second delay bracket 81b being separated from each other are brought into close contact with each other to cause so as to electrically interconnect the second output terminal 104 and the second input terminal 24.

In the standby power cut-off switch according to the present invention, the OFF unit 110 comprises an OFF joint mechanism 130 which is installed at a position spaced apart from a path along which the ON button 14 slides, and a rotating piece 138 formed at one side end thereof is positioned on the sliding path of the ON button 14 in response to the forward and rearward sliding movement or the slidable advancing and retracting movement of one cycle of the ON button 14 and the advancing movement of the locking bar 60 so that the rotating piece 138 is pushed by the ON button 14 to cause the other side end of an OFF joint mechanism 130 to push one side of an OFF bar 134 to allow the other side of the OFF bar 134 to operate the opening/closing unit 40 to thereby allow the second opening/closing unit 44 and the second opening/closing unit 42 in close contact with the second input terminal 24 and the first input terminal 22 to be simultaneously separated from the second input terminal 24 and the first input terminal 22.

In the standby power cut-off switch according to the present invention, the OFF joint mechanism 130 comprises: a pair of supports 133 and 133′ installed beside one side of the opening/closing unit 40 in such a fashion as to be spaced apart from each other, the supports having support holes 133a and 133a′penetratingly formed at the upper ends thereof, respectively; a movable member 136 including a body portion 136b formed in a bar shape, a connecting portion 136a and a press portion 136c formed protrudingly vertically from both ends of the body portion 136b in such a fashion as to oriented in opposite directions, respectively, the movable member 136 being supported by the supports 133 and 133′ such that the press portion 136c and the connecting portion 136a are penetratingly inserted into the support holes 133a and 133a′ of the supports 133 and 133′ so as to be moved in a horizontal direction and being given an elastic restoring force by means of a spring interposed between the support 133a and the body portion 136b so as to allow the press 136c to be fit thereto; the rotating piece 138 formed in a “ [symbol] ” shape which is bent at one end thereof to one side to form a contact end portion 138a and is coupled at the other end thereof to the connecting portion 136a of the movable member 136 by means of a pin so that when the rotating piece 138 can rotate pivotally, the contact end portion 138a is positioned on the sliding path of the ON button 14; and the OFF bar 134 adapted to be horizontally pivotally inserted at a central portion thereof to a rotary shaft 132a formed upright on a fixed stand 132 fixedly mounted to the housing 12 such that when the ON button 14 advances, one end of the OFF bar 134 is pushed by the pressing portion 136c of the movable member 136 to cause the other end of the OFF bar 134 to push the release piece 58 of the opening/closing unit 40 to retract the locking bar 60 in a direction opposite to the slidable advancing direction of the locking bar 60, wherein the locking bar of the opening/closing unit 40 has a retaining jaw 60a formed laterally protrudingly at a distal end thereof, wherein the rotating piece 138 is pin-coupled to the connecting portion 136a in such a fashion that a tip of the other end thereof protrudes externally from the connecting portion 136a by a predetermined length, and wherein a torsion spring is mounted between the rotating piece 138 and the connecting portion 136a to impart elasticity to the rotating piece 138 so that the contact end portion 138a of the rotating piece 138 stays at a position spaced apart from the sliding path of the ON button 14 by means of elasticity of the torsion spring as the locking bar 60 retracts in response to the sliding movement of the ON button, and the contact end portion 138a of the rotating piece 138 is positioned on the sliding path of the ON button 14 by means of pivotal rotation of the rotating piece 138 as the externally protruding tip of the other end of the rotating piece 138 is pushed by the retaining jaw 60a of the locking bar 60 advancing in response to the sliding movement of the ON button 14.

In the standby power cut-off switch according to the present invention, the rotating piece 138 is formed by separately pin-coupling the contact end portion 138a as one end thereof to the other end thereof. In this case, the rotating piece 138 includes a “ [symbol] ”-shaped stopper 138b formed at the other end thereof and a compression spring 138c mounted between the contact end portion 138a and the other end thereof, so that the contact end portion 138a rotates pivotally to prevent the ON button 14 and the contact end portion 138a from interfering each other during the slidable forward movement of the ON button 14 for advancing the locking bar 60 and the rotating piece 138 is held in position to maintain a “ [symbol] ” shape during the slidable rearward movement of the ON button 14 for retracting the locking bar 60 to cause the contact end portion 138a to be positioned on the sliding path of the ON button 14.

In the standby power cut-off switch according to the present invention, the rotating piece 138 is configured such that the contact end portion 138a as one end thereof and the other end thereof are integrally formed with each other to constitute a single rotating piece. The ON button includes a press piece 14b coupled to a distal end thereof by means of a torsion spring and a pin so that the press piece 14b pushes the contact end portion 138a of the rotating piece 138 while being brought into close contact with the contact end portion 138a. Here, a saw-toothed concavo-convex portion is formed on the contact surfaces of the press piece 14b of the ON button 14 and the contact end portion 138a of the rotating piece 138 so that the press piece 14b can stably engage with the contact end portion 138a.

In the standby power cut-off switch according to the present invention, the OFF unit 110 includes the OFF button 120 which is slidably coupled to the housing 12 so that when a user pushes the OFF button 120, it pushes one side of the OFF bar 134 and the other side of the OFF bar 134 operates the opening/closing unit 40 to cause the second opening/closing terminal 44 and the first opening/closing terminal 42 in close contact with the second input terminal 24 and the first input terminal 22, respectively, to be simultaneously separated from the second input terminal 24 and the first input terminal 22, and then the OFF button 120 returns to its original position.

In the standby power cut-off switch according to the present invention, the OFF unit 110 includes a controller 144 operated by receiving the power applied to the inside of the switch through the operation of the opening/closing unit 40 and the delay unit 80 so as to perform a wireless remote control, a sensor 142 connected to the controller 144 for receiving a wireless remote control signal from the controller 144, and an actuator 146 adapted to pull one side of the OFF bar 134 to allow the other side of the OFF bar 134 to operate the opening/closing unit 40 under the control of the controller 144 electrically connected to an internal circuit of the electric product for receiving a signal command from the internal circuit of the electric product to cause the second and first opening/closing terminals 44 and 42 in close contact with the second and first input terminals 24 and 22 to be simultaneously separated from the second and first input terminals 24 and 22.

Meanwhile, in the standby power cut-off switch according to the present invention, the delay unit 80 includes a support block 86 which is spaced apart at one side thereof from the housing 12 to define a space and to which the second opening/closing terminal 44 is coupled, a delay plate 84 to which the second input terminal 24 is fixedly coupled and which includes a support plate 84b pivotally hinged at a lower side thereof to an upper side of the support block 86 by means of a spring so that after the delay plate 84 rotate pivotally, it returns to its original position by the spring, and a delay bar 82 which is coupled at one end thereof to one side of the outer circumferential surface of the ON button 14 in such a fashion as to perpendicularly extend from the outer circumferential surface of the ON button 14 and bent at right angle to be arranged in parallel with the ON button 14 and is disposed at the other end thereof adjacent to one end of the delay plate 84 so that when the ON button 14 is pushed to advance, the delay plate 84 first rotates pivotally so as to allow the second output terminal 104 and the second input terminal 24 to be electrically disconnected from each other and then the opening/closing unit 40 is operated so as to allow the first opening/closing terminal 42 to be brought into close contact with the first input terminal 22 to electrically interconnect the first output terminal 102 and the first input terminal 22, and then when the ON button 14 retracts to return to its original position, the delay plate 84 rotates pivotally to return to its original position to bring the second opening/closing terminal 44 and the second input terminal 24 into close contact with each other so as to allow the second output terminal 104 and the second input terminal 24 to be electrically connected to each other.

### ADVANTAGEOUS EFFECTS

According to the standby power cut-off switch of the present invention, a standby current (or microcurrent) supplied to an electric product is completely interrupted (i.e., double pole interruption) mechanically by only an OFF signal operation of a control circuit constituting an OFF unit of the standby power cut-off switch installed in the electric product whose power plug is connected to an electrical outlet, without using a multitap or removing the power plug from the electrical outlet, and unnecessary use of electric energy is prevented to save power consumption, and short-circuit, electric leakage and static electricity caused by electric current flowing inside the electric product can be prevented.

In addition, according to the present invention, when an electric product is powered on, the first input terminal connected to the power plug is first electrically connected to the first output terminal connected to a main body of the electric product, and then the second output terminal connected to the main body of the electric product is electrically connected to the second input terminal connected to the power plug through the delay unit, thereby preventing a fire due to a large spark and an electric shock to the electric product that may occur between the terminals when the two poles of the switch concurrently come into close contact with the main body of the electric product during the powering on of the electric products.

### DESCRIPTION OF DRAWINGS

FIG. 1 is a block diagram illustrating a standby power cut-off switch according to a technical spirit of the present invention;

FIG. 2 is a perspective view illustrating the main elements of a standby power cut-off switch according to a first preferred embodiment of the present invention;

FIG. 3 is an exploded perspective view illustrating a main construction of an opening/closing unit in the standby power cut-off switch of FIG. 2;

FIGS. 4 and 5 are perspective view illustrating a main construction of an OFF unit in the standby power cut-off switch of FIG. 2;

FIGS. 6 to 10 are perspective views sequentially illustrating an operation mechanism of the standby power cut-off switch of FIG. 2;

FIG. 11 is a perspective view illustrating the main elements of a standby power cut-off switch according to a second preferred embodiment of the present invention;

FIGS. 12 and 13 are perspective view illustrating a main construction of an OFF unit in the standby power cut-off switch of FIG. 11;

FIGS. 14 to 17 are perspective views sequentially illustrating an operation mechanism of the standby power cut-off switch of FIG. 11;

FIG. 18 is a perspective view illustrating the main elements of a standby power cut-off switch according to a third preferred embodiment of the present invention;

FIG. 19 is a perspective views sequentially illustrating an operation mechanism of the standby power cut-off switch of FIG. 18;

FIG. 20 is a perspective view illustrating the main elements of a standby power cut-off switch according to a fourth preferred embodiment of the present invention;

FIG. 21 is an exploded perspective view illustrating a main construction of a delay unit in the standby power cut-off switch of FIG. 20;

FIG. 22 is a perspective views sequentially illustrating an operation mechanism of the standby power cut-off switch of FIG. 20;

FIG. 23 is a perspective view illustrating the main elements of a standby power cut-off switch according to a fifth preferred embodiment of the present invention;

FIGS. 24 to 27 are exploded and assembled perspective views illustrating a main construction of an opening/closing unit in the standby power cut-off switch of FIG. 23;

FIG. 28 is a perspective view sequentially illustrating an operation mechanism of turning on the power supply of the standby power cut-off switch of FIG. 23; and

FIG. 29 is a perspective view sequentially illustrating an operation mechanism of turning off the power supply of the standby power cut-off switch of FIG. 23.

### BEST MODE

A preferred embodiment of the present invention will be described hereinafter in detail with reference to the accompanying drawings.

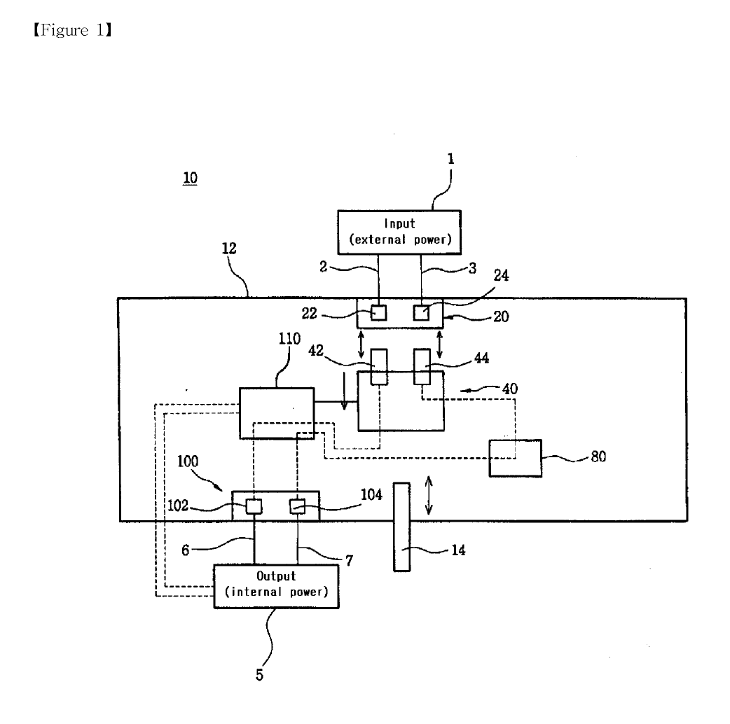

FIG. 1 is a block diagram illustrating a standby power cut-off switch according to a technical spirit of the present invention.

Referring to FIG. 1, the standby power cut-off switch 10 (hereinafter, referred to as “switch”) is adapted to be installed in an electric product for completely interrupting supply of an external power to the electric product through a power plug 1 during the powering on of the electric product, and is characterized in that an opening/closing unit 40 including first and second opening/closing terminals 42 and 44 is installed between first and second input terminals 22 and 24 of an input terminal block 20 and first and second output terminals 102 and 104 of an output terminal block 100 so as to allow the first and second opening/closing terminals 42 and 44 to be brought into close contact with and are separated from the first and second input terminals 22 and 24 of the input terminal block 20, so that the first and second opening/closing terminals 42 and 44 of the opening/closing unit 40 are simultaneously separated from the first and second input terminals 22 and 24 of the input terminal block 20 during the turning-off operation by the OFF unit, thereby completely interrupting supply of the external power to the electric product through the power plug 1. Through such a technical construction, the switch 10 according to the present invention completely prevents the power from being supplied to the inside of the electric product during the turning off of the electric product, thereby eliminating power waste by the standby power (micro power).

In addition, the switch 10 according to the present invention allows a delay unit 80 to be installed between the second input terminal 24 and the second output terminal 104 together with the opening/closing unit 40 so that when the electric product is powered on, the first output terminal 102 is earlier connected to the internal power supply 5 of the electric product and then the second output terminal 104 is later connected to the internal power supply 5 with a time difference, thereby preventing a spark and an electrical shock to the electric product that may occur when the two poles of the switch concurrently come into close contact with a main body of the electric product during the powering on of the electric products.

The switch 10 according to the present invention is characterized in that it is directly installed in an electric product in such a fashion as to remove a power plug from an electrical outlet unlike a conventional prior art while including a double-pole switch construction such as a switch installed at the foremost end of the inside of a house for entirely interrupting the supply of power inputted from the outside of the house, and in that it completely interrupts the standby power of an individual electric product and prevents a safety accident due to electricity.

Particularly, the switch 10 according to the present invention is characterized in that the delay unit 80 prevents two-pole terminals from being concurrently connected to the electric product during the powering on of the electric product so as to solve a problem of double-pole switch in that there is a higher possibility for a spark to occur as compared to a single-pole switch (general switch) and shock may be applied to an electric or electronic circuit of the electric product, giving a damage to it. That is, the switch 10 according to the present invention, the delay unit 80 is aimed to allow the double-pole switch to function as the single-pole switch.

Referring back to FIG. 1, the switch 10 according to the technical spirit of the present invention includes a housing 12, an input terminal block 20, an opening/closing unit 40, an ON button 14, an output terminal block 100 and an OFF unit 110.

The housing 12 refers to an element constituting a frame of the switch 10, and is formed in various shapes depending on the design and mechanical demand so as to be securely fixed to the electric product. As in the preferred embodiment of the present invention, the input terminal block 20 and the output terminal block 100 may be configured variously in terms of its shape and installation position, if necessary, and may adopt a variety of shapes applied to a general switch. A typical input terminal block 20 is a passage through which an external power is inputted through its connection with a power plug 1, and the output terminal block 100 is a passage through which the power applied to the inside of the switch 10 is outputted to an electric or electronic circuit. The input terminal block 20 includes the second input terminal 24 which is connected to a second electric wire 3 of the power plug 1 within the housing 12 and the first input terminal 22 which is connected to a first electric wire 2 of the power plug 1 within the housing 12.

In this case, the first and second input terminals 22 and 24, and the first and second output terminals 102 and 104 are preferably made in the form of a fixed plate of a conductive metal (for example, copper) material. The second opening/closing terminal 44 and the first opening/closing terminal 42 are preferably made in the form of an elastic sheet of a conductive metal (for example, copper) material.

The opening/closing unit 40 is installed within the housing 12, and includes a second opening/closing terminal 44 adapted to be brought into close contact with the second input terminal 24 and a first opening/closing terminal 42 adapted to brought into close contact with the first input terminal 22. Also, the second opening/closing terminal 44 and the first opening/closing terminal 42 are brought into close contact with and are separated from the second input terminal 24 and the first input terminal 22, respectively. Also, in the present invention, the ON button 14 is slidably coupled to the housing 12 so that when a user presses the On button, the opening/closing unit 40 is operated to cause the second opening/closing terminal 44 and the first opening/closing terminal 42 to be brought into close contact with the second input terminal 24 and the first input terminal 22, respectively, and then the ON button returns to its original position. In addition, the OFF unit 110 is disposed in the housing, and operates the opening/closing unit 40 in a state where the second opening/closing terminal 44 and the first opening/closing terminal 42 of the opening/closing unit 40 are in close contact with the second input terminal 24 and the first input terminal 22, respectively, so that the second opening/closing terminal 44 and the first opening/closing terminal 42 are simultaneously separated (opened) from the second input terminal 24 and the first input terminal 22. In this case, as can be seen in the preferred embodiment of the present invention, since the OFF unit 110 is operated in a state where an electric power is supplied to the inside of the switch, i.e., the inside of the electric product, it can be controlled by a remote control manner or an automatic manner and is electrically connected to an internal circuit of the electric product to receive a signal from the inner circuit.

According to such a construction, in the switch 10 of the present invention, the output terminal block 100 includes a second output terminal 104 which is connected to a second electric wire 7 of an internal power supply line 5 extending to the inside (main body) of the electric product in such a fashion as to be electrically connected to the second opening/closing terminal 44 of the opening/closing unit 40 within the housing 12, and a first output terminal 102 which is connected to a first electric wire 6 of the internal power supply line 5 extending to the inside (main body) of the electric product in such a fashion as to be electrically connected to the first opening/closing terminal 42 of the opening/closing unit 40.

In the meantime, as described above, the switch 10 according to the present invention further includes a delay unit 80 adapted to be operated by the pushing of the ON button 14 so as to prevent a large spark occurring substantially when the electric product is powered on and reduce an electrical shock to the internal circuit of the electric product. The delay unit 80 may be disposed between the second input terminal 24 and the second output terminal 104.

Such a delay unit 80 does not allow for the electrical connection between the second output terminal 104 and the second input terminal 24, i.e., allows the second output terminal 104 and the second input terminal 24 to be opened irrespective of whether or not the opening/closing unit 40 is operated upon the depression of the ON button 14, and when the ON button 14 returns to its original position, the second output terminal 104 and the second input terminal 24 are connected to each other, such that the first input terminal 22 and the first output terminal 102 are first connected to each other and then the second input terminal 24 and the second output terminal 104 are connected to each other so as to supply the power to the main body of the electric product.

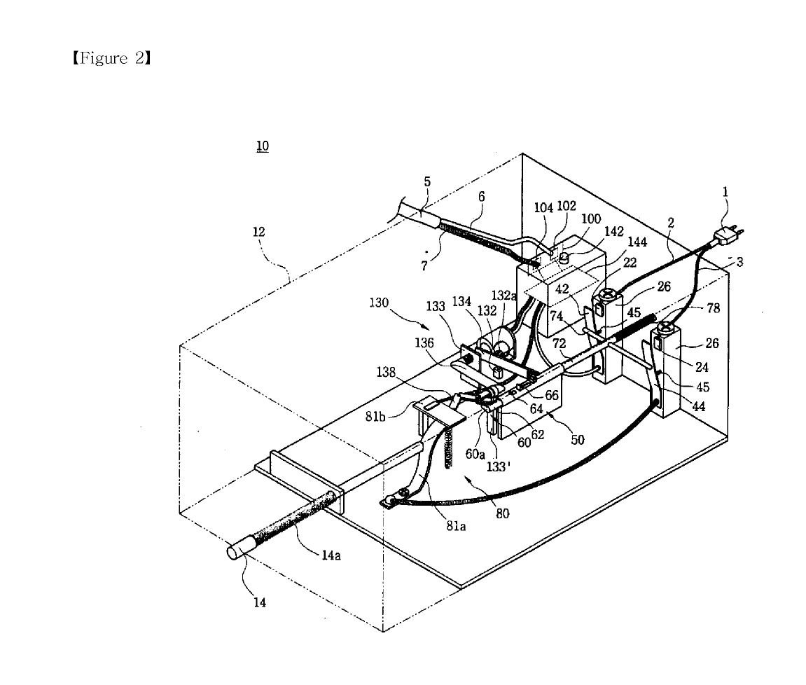

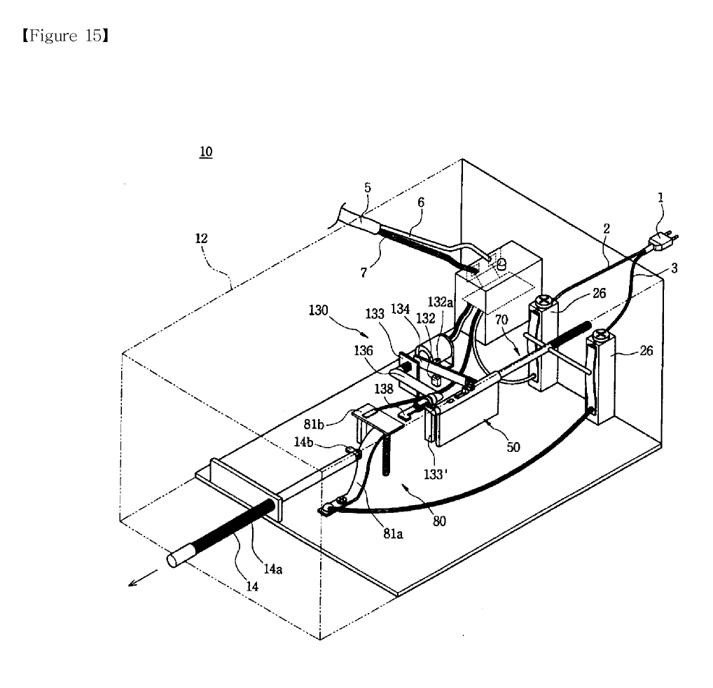

Now, the preferred embodiments of the present invention will be described hereinafter in detail with reference to FIGS. 2 to 29. The same reference numerals are used to designate the same or similar elements through FIGS. 2 to 29. Meanwhile, in the drawings, illustration and detailed description on the construction, its operation and effects which can be readily understood by those skilled in the art will be simplified or omitted, and parts related to the present invention are illustrated in detail.

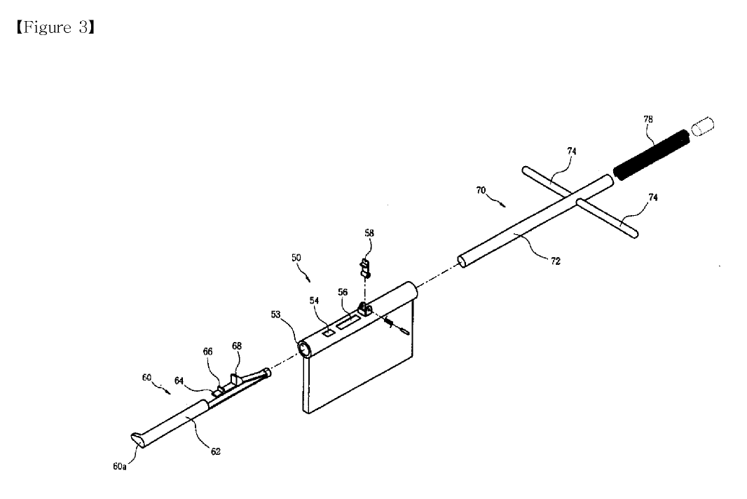

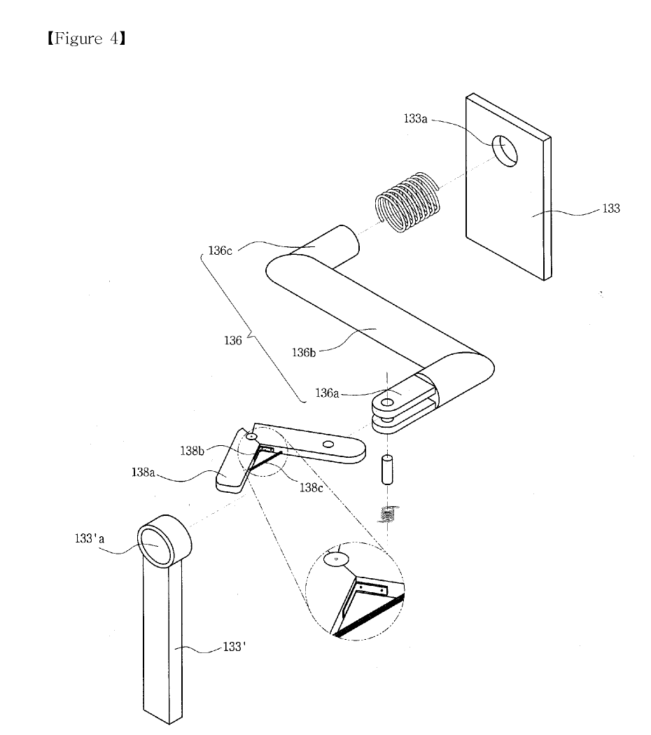

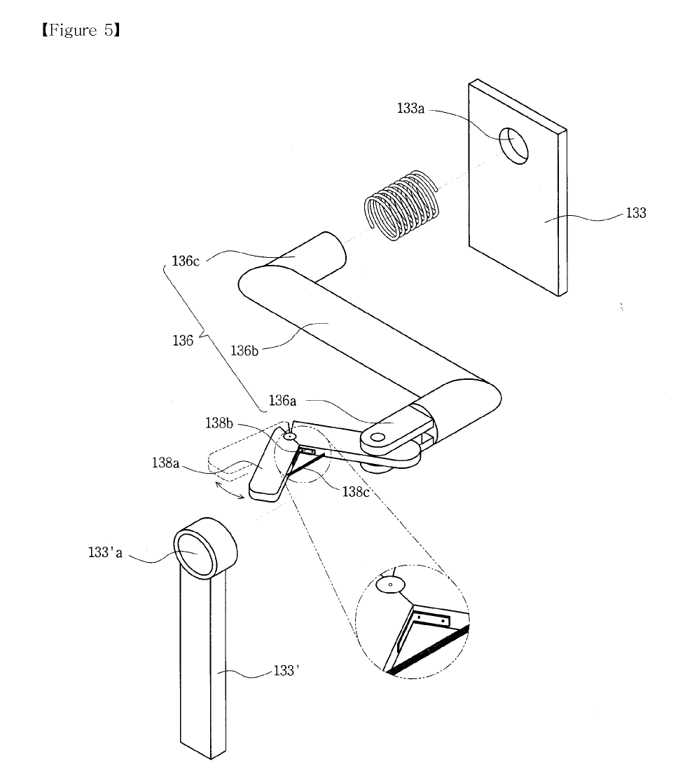

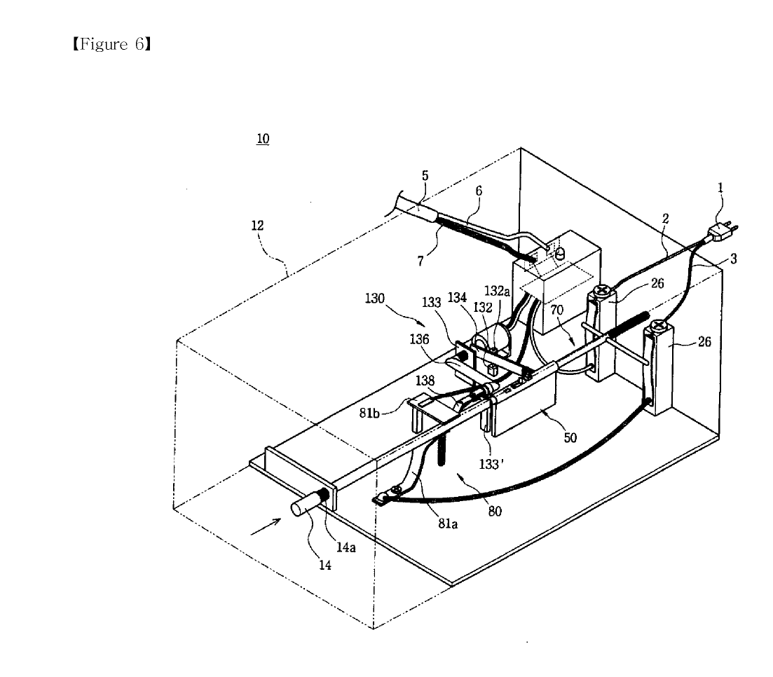

FIG. 2 is a perspective view illustrating the main elements of a standby power cut-off switch according to a first preferred embodiment of the present invention, FIG. 3 is an exploded perspective view illustrating a main construction of an opening/closing unit in the standby power cut-off switch of FIG. 2, FIGS. 4 and 5 are perspective view illustrating a main construction of an OFF unit in the standby power cut-off switch of FIG. 2, and FIGS. 6 to 10 are perspective views sequentially illustrating an operation (ON and OFF) mechanism of the standby power cut-off switch of FIG. 2.

Referring to FIGS. 2 to 5 the switch 10 according to a first preferred embodiment of the present invention includes the housing 12, the ON button 14, the input terminal block 20, (see FIG. 1), the opening/closing unit 40 (see FIG. 1), the delay unit 80 (see FIG. 1), the output terminal block 100 and the OFF unit 110.

In this case, the ON button 14 is configured such that after being pushed (or operated) by a user by means of a spring 14a supported by the housing 12, it returns to its original (initial) position, i.e., a state where the user does not push it. Of course, in the first preferred embodiment of the present invention, the ON button 14 is formed in the most simple bar shape, but may adopt a variety of structures in this field.

In the first preferred embodiment of the present invention, the input terminal block 20 includes a second input terminal 24 which is connected to a second electric wire 3 of the power plug 1 within the housing 12 and a first input terminal 22 which is connected to a first electric wire 2 of the power plug 1 within the housing 12. In this case, as shown in FIG. 2, the second input terminal 24 and the first input terminal 22 of the input terminal block 20 is arranged perpendicularly to a sliding direction of the ON button 14. Also, the second input terminal 22 and the first input terminal 22 of the input terminal block 20 are securely fixed to an upper end portion of a support block 26 to have the same height as each other.

As described above, the opening/closing unit 40 of the switch 10 according to the first preferred embodiment of the present invention is installed within the housing 12, and includes a second opening/closing terminal 44 adapted to be brought into close contact with the second input terminal 24 and a first opening/closing terminal 42 adapted to brought into close contact with the first input terminal 22. In this case, in this embodiment, the second opening/closing terminal 44 and the first opening/closing terminal 42, as shown in FIG. 2, are arranged perpendicularly to a sliding direction of the ON button 14. Here, one end of the first opening/closing terminal 42 is securely fixed to a lower end portion of the support block 26 to which the first input terminal 22 is fixed and is electrically connected to the first output terminal 102 via a remote module 140. The other end of the first opening/closing terminal 42 is spaced apart from the first input terminal 22 at a position corresponding to the first input terminal 22 so as to be elastically movable to be brought into close contact with and separated (opened) from the first input terminal 22. Also, one end of the second opening/closing terminal 44 is securely fixed to a lower end portion of the support block 26 to have the same height as that of the first opening/closing terminal 42 and is electrically connected to the second output terminal 104 via the remote module 140. The other end of the second opening/closing terminal 44 is spaced apart from the second input terminal 24 at a position corresponding to the second input terminal 24 so as to be elastically movable to be brought into close contact with and separated (opened) from the second input terminal 24. The structure in which the second opening/closing terminal 44 and the first opening/closing terminal 42 are elastically movable may be implemented basically by bending a sheet material as shown in FIG. 2, but may be given an elastic force stably by additionally installing a spring 45 to a lower portion thereof. Of course, such a structure can adopt a variety of shapes provided typically in this field.

As shown in FIGS. 2 and 3, the opening/closing unit 40 of the switch 10 according to the first preferred embodiment of the present invention includes a supporting barrel 50, a locking bar 60 and a pressing bar 70 besides the first opening/closing terminal 42 and the second opening/closing terminal 44. The supporting barrel 50 includes a hollow portion 53 opened at front and rear ends thereof and is supportedly fixed to the housing 12 in such a fashion that the hollow portion 53 thereof is arranged in parallel with a sliding direction of the ON button 14. The hollow portion 53 of the supporting barrel 50 includes a first aperture 54 and a second aperture 56 formed penetratingly on the outer circumference thereof in such a fashion as to be arranged in parallel with each other. Also, the supporting barrel 50 includes a release piece 58 mounted on the outer circumferential surface of the hollow portion 53 so as to be positioned adjacent to the second aperture 56. The release piece 58 is hingeably coupled to the outer circumferential surface of the hollow portion 53 so as to rotate by means of a spring. The release piece 58 is operated by the OFF unit 110 so that a first stopper 66 and a second stopper 68 of the locking bar 60 engage with the second aperture 56 of the supporting barrel 50 via the first aperture 54 so as to allow the second opening/closing terminal 44 and the first opening/closing terminal 42 to be simultaneously separated (opened) from the second input terminal 24 and the first input terminal 22. In this case, the second stopper 68 is preferably made greater in height than the first stopper 66 so as to allow the release piece 58 to easily escape the first stopper 66 from the second aperture 56.

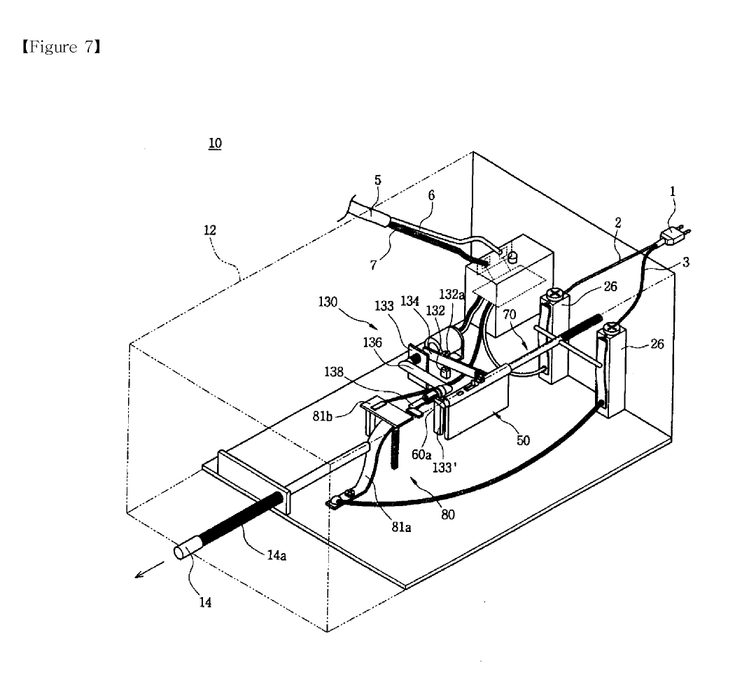

The locking bar 60 and the pressing bar 70 are coupled to both sides of the supporting barrel 50 in such a fashion as to be operated in cooperation with each other. In this case, the locking bar 60 includes a main rod 62 and a sub-rod 64 branched off from the main rod 62 so as to be elastically moved, so that the main rod and the sub-rod are slidably coupled to the hollow portion 53 of the supporting barrel 50 in a direction where the ON button is oriented. Also, the sub-rod 64 of the locking bar 60 has the first stopper 66 and the second stopper 68 protrudingly formed on the top surface thereof so that when the locking bar 60 is coupled to the supporting barrel 50, the first stopper 66 and the second stopper 68 engage with the first aperture 54 and the second aperture 56, respectively. As shown in FIGS. 6 and 7, the locking bar 60 is operated such that when the ON button 14 is pushed, the first stopper 66 and the second stopper 68 engage with the second aperture 56 together so as to be held in position to cause the pressing bar 70 to maintain a converted position, i.e., a position where the second opening/closing terminal 44 and the first opening/closing terminal 42 are pressed. Of course, the operation of the locking structure of the supporting barrel 50 and the locking bar 60 has been verified by virtue of the long use thereof in a retractable ball point pen.

In this case, the pressing bar 70 includes a column 72 and a loader 74 extending outwardly from one side of the column 72 in such a fashion as to be oriented perpendicular to the column 72 so as to press one sides of the second opening/closing terminal 44 and the first opening/closing terminal 42 with a uniform force. The pressing bar 70 is sildably coupled at one end thereof to the hollow portion 53 of the supporting barrel 50 so as to be opposed to the locking bar 60 and is supported at the other end thereof by a spring 78 supportedly mounted to the housing 12.

As shown in FIG. 6, the opening/closing unit 40 having the above construction is operated by the ON button 14 pushed by a user to cause the second opening/closing terminal 44 and the first opening/closing terminal 42 to be brought into close contact with the second input terminal 24 and the first input terminal 22, respectively.

The operation of the opening/closing unit 40 having the above construction will be described hereinafter.

First, in order for a user to turn on the power supply of the electric product in a state where it is powered off as shown in FIG. 2, when the user pushes the ON button 14, it advances in the sliding direction of the ON button so as to push the locking bar 60 supported slidably by the supporting barrel 50. Then, the locking bar 60 advances into the hollow portion of the supporting barrel 50 to push the pressing bar 70 operated in cooperation with the locking bar 60. In this process, the loader 74 of the pressing bar 70 pushes the second opening/closing terminal 44 and the first opening/closing terminal 42 in a downstream direction, i.e., in the sliding direction of the ON button 14 to cause the second opening/closing terminal 44 and the first opening/closing terminal 42 to be brought into close contact with the second input terminal 24 and the first input terminal 22 and simultaneously the locking bar 60 to maintain a state where the first stopper 66 is inserted into and retained in the second aperture 56 of the supporting barrel 50 so as to be held in position, so that although the ON button returns to its initial (original) position, the loader 74 of the pressing bar 70 allows the second opening/closing terminal 44 and the first opening/closing terminal 42 to be brought into close contact with the second input terminal 24 and the first input terminal 22.

In the meantime, as described above, the switch 10 according to the present invention further includes the delay unit 80 for preventing a large spark occurring substantially when the electric product is powered on and reducing an electrical shock to the internal circuit of the electric product. The delay unit 80 is disposed between the second input terminal 24 and the second output terminal 104 and is operated by the pushing of the ON button 14. The delay unit 80 allows the electrical contact between the terminals at the installation position, i.e., between the second input terminal 24 and the second output terminal 104 to be opened upon the pushing of the ON button 14, so that although the opening/closing unit 40 is operated, the opened state of the electrical contact between the terminals is maintained, and when the ON button 14 returns to its original position, the second input terminal 24 and the second output terminal 104 are again brought into close contact with each other, i.e., the electrical contact between the second input terminal 24 and the second output terminal 104 are closed. As a result, the first input terminal 22 is brought into close contact with the first opening/closing terminal 42 so as to be electrically connected to the first output terminal 102, and then the second output terminal 104 and the second input terminal 24 are electrically connected to each other.

In the first preferred embodiment of the present invention, as shown in FIGS. 2, 6 and 7 the delay unit 80 includes a first delay bracket 81a, a support block 90 and a second delay bracket 81b. The first delay bracket 81a is disposed between the supporting barrel 50 and the ON button 14 in such a fashion as to be oriented horizontal to the sliding direction of the ON button 14. The first delay bracket 81a is fixed to the housing 12 and connected to the second opening/closing terminal 44 by an electric wire at one end thereof, and is brought in close contact with the second delay bracket 81b at the other end thereof so that the other end of the first delay bracket 81a is pressed and elastically moved upon the pushing of the ON button 14 so as to be separated from the second delay bracket 81b. Also, the support block 90 is disposed between the first delay bracket 81a and the supporting barrel 50 in such a fashion as to be securely fixed to the housing 12, and the second delay bracket 81b is fixed to the top end of the support block 90. The support block 90 is installed at a position spaced apart from a path along which the ON button 14 slides so as to prevent its interference with the ON button 14. The second delay bracket 81b is joined to the top end of the support block 90 so as to abut against the first delay bracket 81a and electrically connected at one side thereof to the second output terminal 104 by an electric wire via a remote module 140. Meanwhile, a fixed one side of the first opening/closing terminal 42 is connected to the remote module 140 by an electric wire so as to be electrically connected to the first output terminal 102.

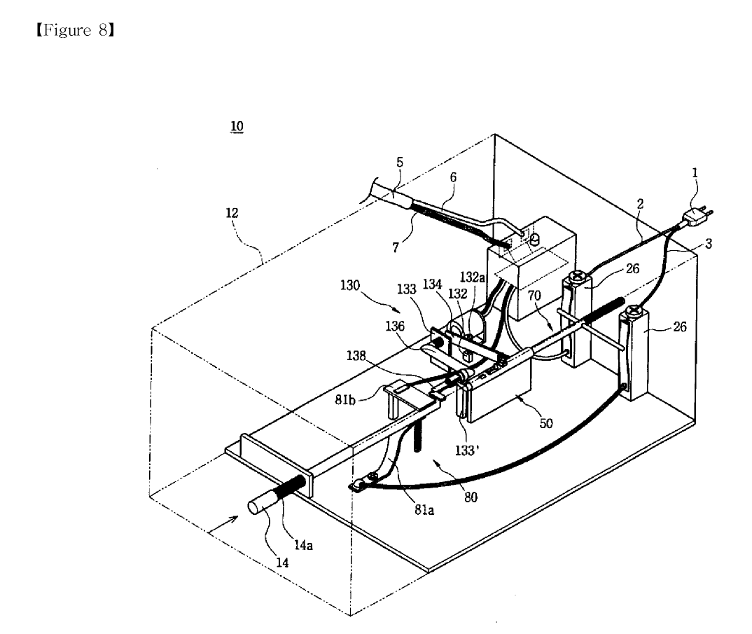

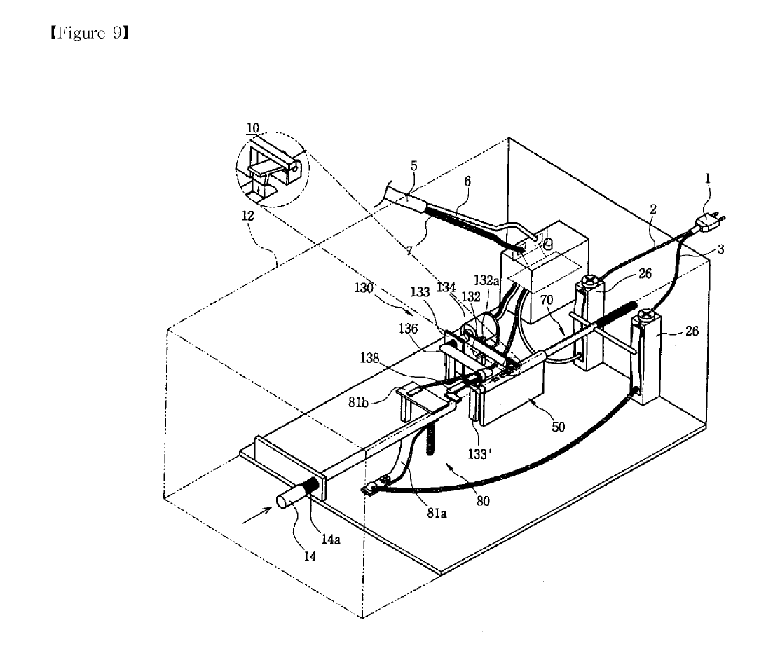

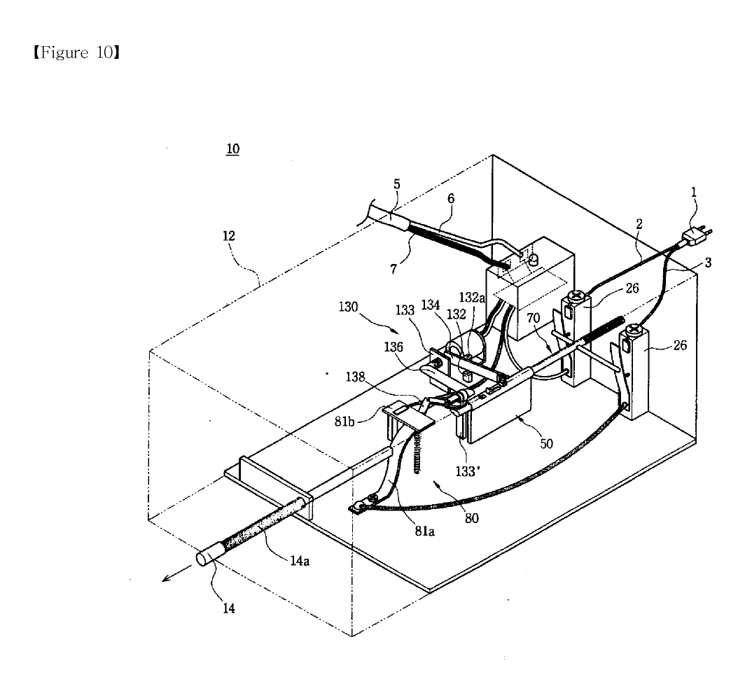

Through the construction of the delay unit 80, the switch 10 according to the first embodiment of the present invention, when a user pushes the ON button 14 while turning on the power supply as shown in FIG. 6 in a state where the electric product is powered off as shown in FIG. 2, the ON button slidably advances to cause the first delay bracket 81a and the second delay bracket 81b in close contact with each other to be separated from each other, i.e., the electrical contact between the first delay bracket 81a and the second delay bracket 81b is opened. Also, in the same manner as in the above-mentioned first embodiment, the second opening/closing terminal 44 and the first opening/closing terminal 42 are brought into close contact with the second input terminal 24 and the first input terminal 22. In this case, the second input terminal 24 and the first input terminal 22 are fixedly attached to the support block 26 in the form of the same height and shape. In this embodiment, as shown in FIG. 7, when the ON button 14 returns to its original position, the first delay bracket 81a and the second delay bracket 81b are brought into close contact with each other so that the power supply is sequentially connected to the first and second output terminals 102 and 104 connected to the internal power supply line 5, but simultaneously not connected to the first and second output terminals 102 and 104. In addition, as shown in FIGS. 8 and 9, the OFF unit 110 is operated to push an OFF bar 134 to cause the opening/closing unit 40 to be operated so that the second opening/closing terminal 44 and the first opening/closing terminal 42 are simultaneously separated from the second input terminal 24 and the first input terminal 22 as shown in FIG. 10.

In this case, the first delay bracket 81a is preferably made in the form of an annular elastic sheet of a conductive metal (for example, copper) material, and preferably includes a spring disposed between one side of the first delay bracket 81a and a bottom surface of the housing 12 so as to impart an elastic force. The second delay bracket 81b is also preferably made in the form of a sheet of a conductive metal (for example, copper) material.

Meanwhile, the OFF unit 110 is disposed in the housing and operates the opening/closing unit 40 in a state where the second opening/closing terminal 44 and the first opening/closing terminal 42 of the opening/closing unit 40 are in close contact with the second input terminal 24 and the first input terminal 22, respectively, so that the second opening/closing terminal 44 and the first opening/closing terminal 42 are simultaneously separated from the second input terminal 24 and the first input terminal 22, respectively. The OFF unit 110 may be configured to selectively use the OFF joint mechanism 130 and/or the remote module 140.

In this case, the OFF joint mechanism 130 is installed at a position spaced apart from a path along which the ON button 14 slides, and retracts the locking bar 60 of the opening/closing unit 40 for allowing the first and second opening/closing terminals 42 and 44 to advance to be brought into close contact with the first and second input terminals 22 and 24 in response to the sliding operation of the ON button 14 so as to return the locking bar 60 to its original position so that the first and second opening/closing terminals 42 and 44 are separated from the first and second input terminals 22 and 24.

The OFF joint mechanism 130 includes a pair of supports 133 and 133, a movable member 136, a rotating piece 138 and an OFF bar 134.

The supports 133 and 133′ are installed at one side of the opening/closing unit 40 so as to support the movable member 136 at a predetermined height. To this end, the supports 133 and 133′ have support holes 133a and 133a′ penetratingly formed at the upper ends thereof, respectively, so as to allow both distal ends of the movable member 136 to be inserted thereto. Also, the pair of supports 133 and 133′ are mounted to the bottom of the housing 12 in such a fashion as to be spaced apart from each other and allows the both ends of the movable member 136 to be inserted into the support holes 133a and 133a′of the supports 133 and 133′ so as to stably hold the movable member 136 in position.

The movable member 136 includes a body portion 136b formed in a bar shape having the same length as the distance between the pair of supports 133 and 133′ spaced apart from each other, a connecting portion 136a protrudingly extending vertically from one end of the body portion 136b so as to be penetratingly inserted into the support hole 133a′of one side support 133′, and a press portion 136c protrudingly extending vertically from the other end of the body portion 136b in an direction opposite to the orientation direction of the connecting portion 136a so as to be penetratingly inserted into the support hole 133a of the other side support 133. Since the body portion 136b, the connecting portion 136a and the press portion 136c are formed integrally with each other, the movable member 136 is moved as a single body. The movable member 136 is supported by the supports 133 and 133′ as constructed above such that the press portion 136c and the connecting portion 136a are penetratingly inserted into the support holes 133a and 133a′of the supports 133 and 133′ so as to be moved in a horizontal direction. In addition, a spring is interposed between the support 133a and the body portion 136b so as to allow the press portion 136c to be fit thereto to impart an elastic restoring force to the movable member 136. Here, the connecting portion 136a of the movable member 136 is coupled to the rotating piece 138, and the press portion 136c of the movable member 136 is operated in cooperation with the OFF bar 134 so that the movable member 136 is horizontally moved by the rotating piece 138 to cause the OFF bar 134 to be operated.

The rotating piece 138 is generally formed in a “ [symbol] ” shape which is bent at one end thereof to one side to form a contact end portion 138a. The rotating piece 138 is coupled at the other end thereof to the connecting portion 136a of the movable member 136 by means of a pin so that the rotating piece 138 can rotate pivotally. The rotating piece 138 rotates pivotally by the forward and rearward sliding movement or the slidable advancing and retracting movement of the ON button 14 and the slidable advancing and retracting movement of the locking bar 60 of the opening/closing unit 40. To this end, the rotating piece 138 is pin-coupled to the connecting portion 136a in such a fashion that a tip of the other end thereof protrudes externally from the connecting portion 136a by a predetermined length. Also, the locking bar 60 has a retaining jaw 60a formed laterally protrudingly at a distal end thereof so that the externally protruding tip of the other end of the rotating piece 138 is pushed by the retaining jaw 60a of the locking bar 60 in response to the forward and rearward sliding movement of one cycle of the ON button 14 and the advancing movement of the locking bar 60 so as to pivotally rotate the rotating piece 138. In addition, a torsion spring is mounted between the rotating piece 138 and the connecting portion 136a. The torsion spring serves to impart elasticity to the rotating piece 138 so that in a state where the locking bar 60 retracts to return its original position, the rotating piece 138 also returns to its original position so as to be maintained in a state where the tip of the other end of the rotating piece 138 protrudes externally from the connecting portion 136a by a determined length and the contact end portion 138a of the rotating piece 138 stays at a position spaced apart from the sliding path of the ON button 14.

The rotating piece 138 as constructed above rotates pivotally to one side in response to the advancing movement of the locking bar 60 so as to be positioned on the sliding path of the ON button 14. Also, when the ON button 14 again slides forwardly to retract the locking bar 60, the rotating piece 138 is pushed by the ON button 14 to advance the movable member 136. In this case, the ON button 14 pushes the contact end portion 138a of the rotating piece 138 to advance the movable member 136.

The rotating piece 138 according to the first preferred embodiment of the present invention is formed by separately pin-coupling the contact end portion 138a as one end thereof to the other end thereof. Thus, the contact end portion 138a can rotate pivotally with respect to the other end of the rotating piece 138. In this case, the rotating piece 138 includes a “ [symbol] ”-shaped stopper 138b formed at the other end thereof and a compression spring 138c mounted between the contact end portion 138a and the other end thereof so as to allow the contact end portion 138a and the other end of the rotating piece 138 to entirely maintain a “ [symbol] ” shape. In this case, the contact end portion 138a pulled by the compression spring 138c comes into close contact with the stopper 138b formed at the other end of the rotating piece 138 so as to maintain the “ [symbol] ” shape. Also, the stopper 138b serves to firmly support the contact end portion 138a positioned on the sliding path of the ON button 14 when the ON button 14 pushes the contact end portion 138a. In the meantime, instead of the compression spring 138c, a torsion spring may be preferably mounted between the rotating piece 138 forming the one end of the rotating piece 138 and the other end of the rotating piece 138 with the torsion spring fit around a pin. In other words, the compression spring 138c or the torsion spring is provided between the rotating piece 138 and the other end of the rotating piece 138 to impart elasticity to the rotating piece so as to prevent a distal end of one side of the contact end portion 138a in close contact with the outer circumferential surface of the ON button 14 during the advancing movement of the locking bar 60 from interfering the retracting sliding movement (i.e., returning movement to its original position) of the ON button 14. The contact end portion 138a and the other end of the rotating piece 138 according to the first preferred embodiment of the present invention can elastically rotate pivotally, so that when the rotating piece 138 rotates pivotally in the direction of the sliding path of the ON button 14 in response to the advancing movement of the ON button 14 and the locking bar 60, it may takes a nearly linear shape while coming into close contact with the outer circumferential surface of the ON button 14, and so that when the ON button 14 retracts to return to its original position, the rotating piece 138 has a “ [symbol] ” shape again as the contact end portion 138a is pulled by the compression spring 138c to enable the ON button 14 and the contact end portion 138a to come into close contact with each other upon the advancing sliding movement of the ON button 14.

The OFF bar 134 is horizontally pivotally inserted at a central portion thereof to a rotary shaft 132a formed upright on a fixed stand 132 fixedly mounted to the housing 12 so as to rotate pivotally within a predetermined range. The OFF bar 134 preferably includes a torsion spring to impart an elastic restoring force. The OFF bar 134 is operated at one end thereof in cooperation with the press portion 136c of the movable member 136 and is operated at the other end thereof in cooperation with the release piece 58 of the opening/closing unit 40. Thus, when the movable member 136 advances by the ON button 14 in close contact with the contact end portion 138a of the rotating piece 138, the press portion 136c of the movable member 136 pushes one side of the OFF bar 134 to cause the OFF bar 134 to rotate pivotally about the rotary shaft 132a of the fixed stand 132 and simultaneously the other side of the OFF bar 134 to operate the release piece 58 of the opening/closing unit 40 to retract the locking bar 60, so that the first and second opening/closing terminals 42 and 44 in close contact with the first and second input terminals 22 and 24 are simultaneously separated from the first and second input terminals 22 and 24. Therefore, each time the ON button 14 repeatedly performs the forward and rearward sliding movement of one cycle, the switch is alternately turned on and off.

In the meantime, the remote module 140 includes a controller 144, a sensor 142 and an actuator 146. The controller 144 is operated by receiving the power applied to the inside of the switch through the operation of the opening/closing unit 40 and the delay unit 80, and performs a wireless remote control and an automatic control. The sensor 142 is connected to the controller 144 to receive a wireless remote control signal. In addition, the controller 144 may be connected to an internal circuit of the electric product by means of an electric wire to receive a signal command from the internal circuit of the electric product. The actuator 146 may employ an electromagnet as a representative example thereof. In this case, the OFF bar 134 operating the release piece 58 employs a metal material responding to magnetism. The actuator 146 by the control of the controller 144 pulls one side of the OFF bar 134 to operate the release piece 58 of the opening/closing unit 40 to cause the first and second opening/closing terminals 42 and 44 in close contact with the first and second input terminals 22 and 24 to be simultaneously separated from the first and second input terminals 22 and 24. Like this, since the OFF unit 110 is operated in a state where the power is supplied to the electric product, the automatic control such as the remote control and the like can be made.

According to such a construction, in the switch 10 according to the first preferred embodiment of the present invention, the output terminal block 100 includes a second output terminal 104 which is connected to a second electric wire 7 of an internal power supply line 5 extending to the inside of the electric product in such a fashion as to be electrically connected to the second opening/closing terminal 44 of the opening/closing unit 40 within the housing, and a first output terminal 102 which is connected to a first electric wire 6 of the internal power supply line 5 extending to the inside of the electric product in such a fashion as to be electrically connected to the first opening/closing terminal 42 of the opening/closing unit 40 within the housing.

Meanwhile, in the switch 10 according to the first preferred embodiment of the present invention, the delay unit 80 may be configured in the form of a delay unit 80 included in the fourth preferred embodiment of the present invention. Such a delay unit 80 includes a support block 86 which is spaced apart at one side thereof from the housing 12 to define a space and to which the second opening/closing terminal 44 is coupled, a delay plate 84 to which the second input terminal 24 is fixedly coupled and which includes a support plate 84b pivotally hinged at a lower side thereof to an upper side of the support block 86 by means of a spring so that after the delay plate 84 rotate pivotally, it returns to its original position by the spring, and a delay bar 82 which is coupled at one end thereof to one side of the outer circumferential surface of the ON button 14 in such a fashion as to perpendicularly extend from the outer circumferential surface of the ON button 14 and bent at right angle to be arranged in parallel with the ON button 14 and is disposed at the other end thereof adjacent to one end of the delay plate 84 so that when the ON button 14 is pushed to advance, the delay plate 84 first rotates pivotally so as to allow the second output terminal 104 and the second input terminal 24 to be electrically disconnected from each other and then the opening/closing unit 40 is operated so as to allow the first opening/closing terminal 42 to be brought into close contact with the first input terminal 22 to electrically interconnect the first output terminal 102 and the first input terminal 22, and then when the ON button 14 retracts to return to its original position, the delay plate 84 rotates pivotally to return to its original position to bring the second opening/closing terminal 44 and the second input terminal 24 into close contact with each other so as to allow the second output terminal 104 and the second input terminal 24 to be electrically connected to each other.

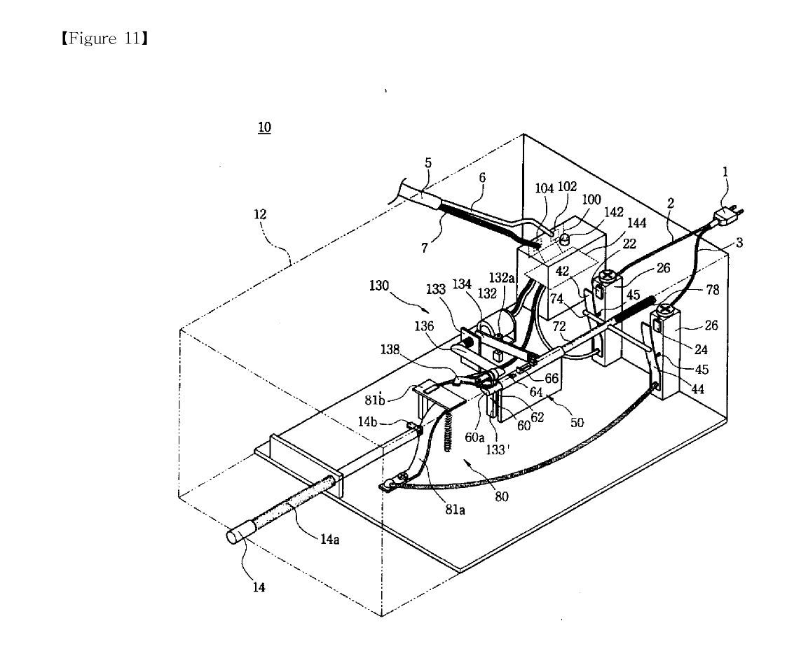

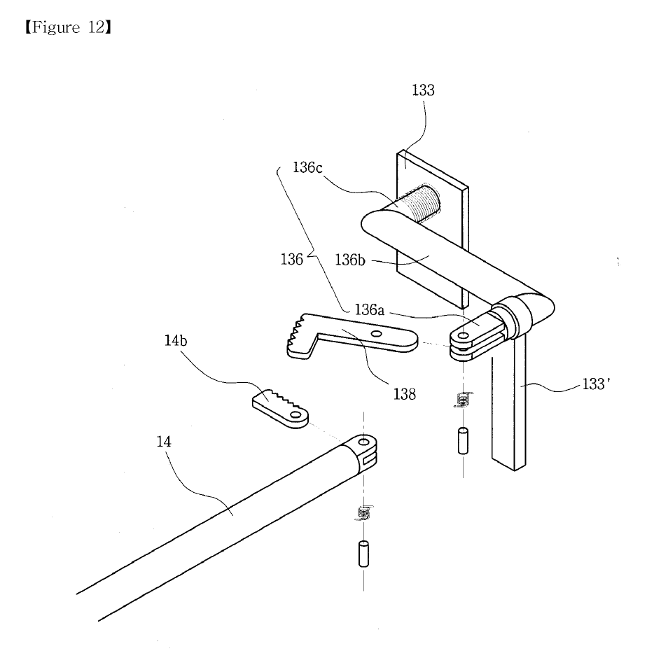

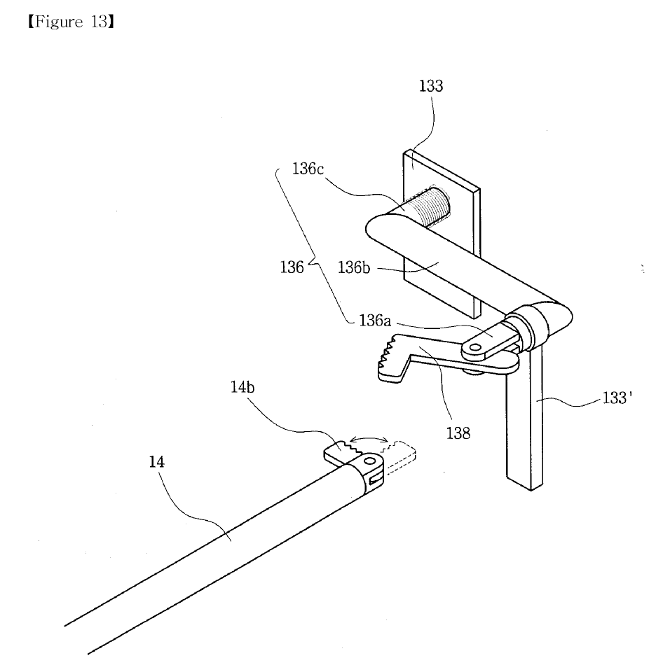

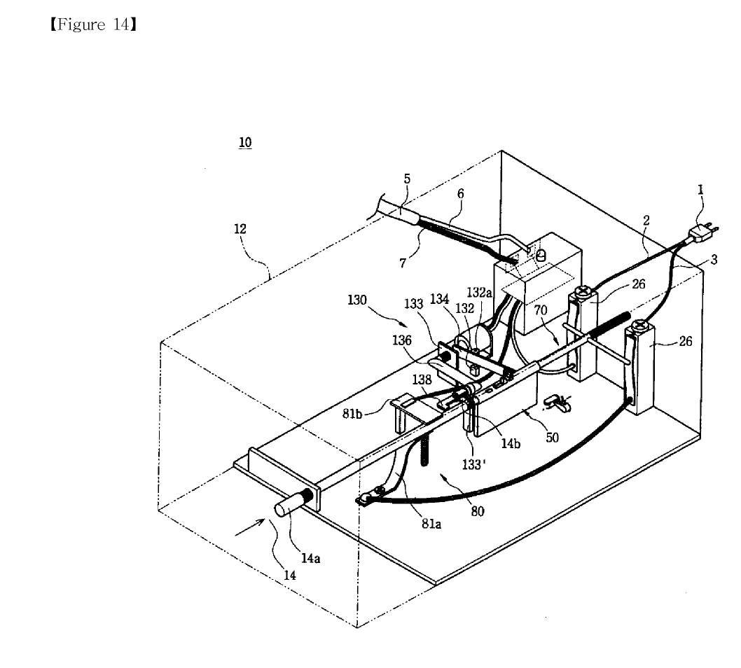

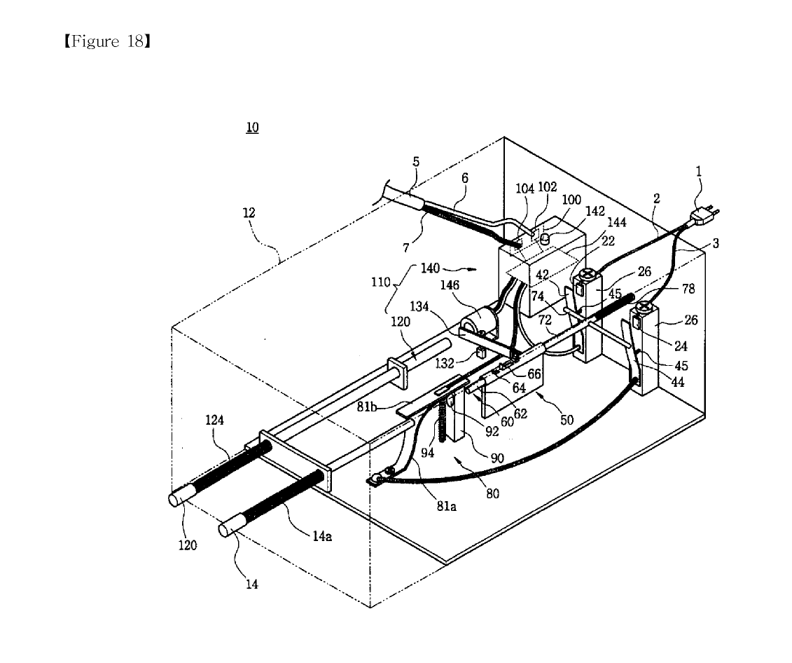

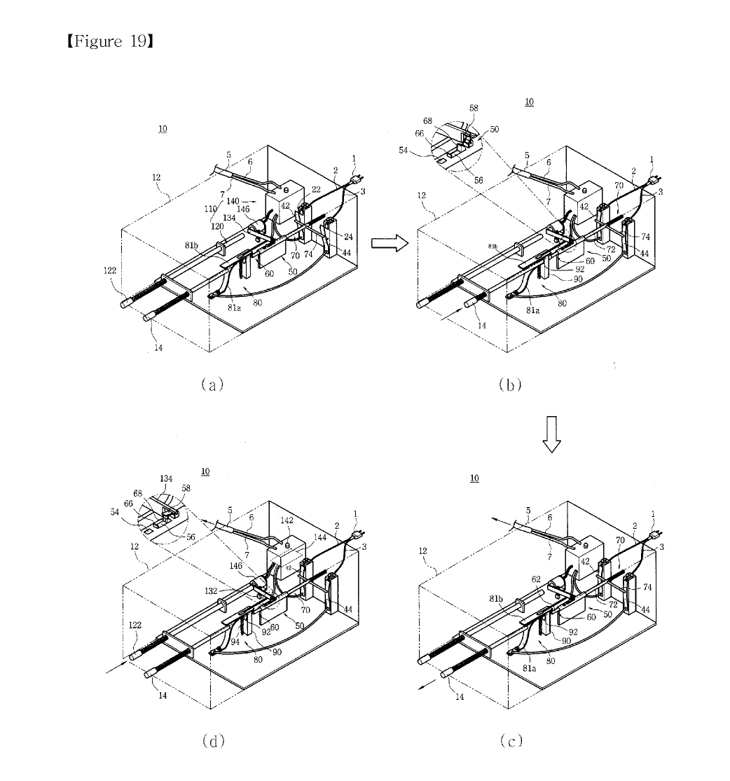

FIG. 11 is a perspective view illustrating the main elements of a standby power cut-off switch according to a second preferred embodiment of the present invention, FIGS. 12 and 13 are perspective view illustrating a main construction of an OFF unit in the standby power cut-off switch of FIG. 11, FIGS. 14 to 17 are perspective views sequentially illustrating an operation mechanism of the standby power cut-off switch of FIG. 11, FIG. 18 is a perspective view illustrating the main elements of a standby power cut-off switch according to a third preferred embodiment of the present invention, and FIG. 19 is a perspective views sequentially illustrating an operation mechanism of the standby power cut-off switch of FIG. 18.

A switch 10 according to the second preferred embodiment of the present invention and a switch 10 according to the third preferred embodiment include a housing 12, an ON button 14, an input terminal block 20 (see FIG. 1), an opening/closing unit 40 (see FIG. 1), a delay unit 80, and output terminal block 100 and an OFF unit 110 as in the first preferred embodiment as described above. In this case, since the constructions and operations of the switches 10 according to the second and third preferred embodiments of the present invention are the same as those of the aforementioned first preferred embodiment except the OFF unit 110, the detailed description thereof will be omitted.

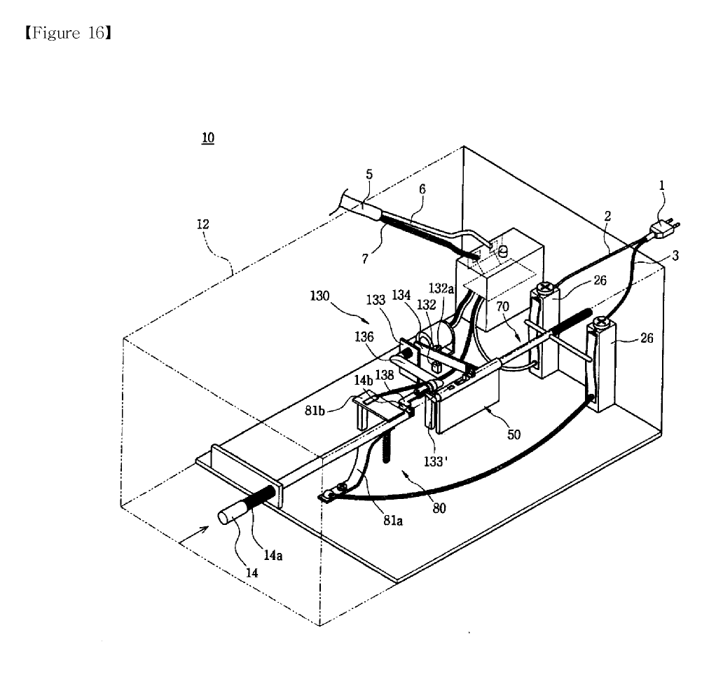

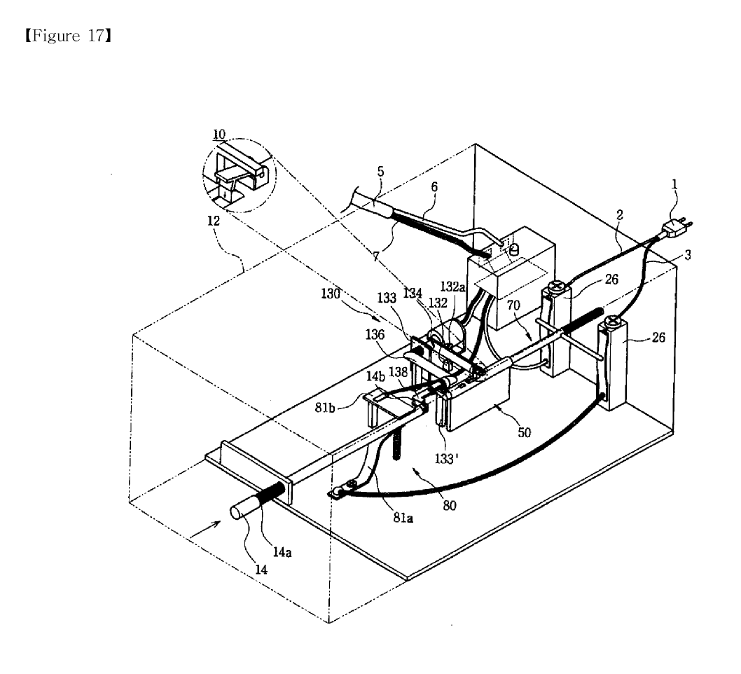

The OFF unit 110 according to the second preferred embodiment of the present invention is configured differently from the OFF unit 110 according to the first preferred embodiment in that the contact end portion 138a and the other end of the rotating piece 138 are integrally formed with each other to constitute a single rotating piece 138. Also, the ON button includes a press piece 14b coupled to a distal end thereof by means of a torsion spring and a pin so that after the press piece 14b rotates pivotally, it can returns to its original position by an elastic restoring force of the torsion spring. Thus, as shown in FIG. 14, in the case where the ON button 14 advances to forwardly move the locking bar 60 and then retracts to return to its original position, when the press piece 14b of the ON button 14 is brought into close contact with the contact end portion 138a of the rotating piece 138 positioned on the sliding path of the ON button 14 by the forward movement of the locking bar 60, it rotates pivotally in a direction of not interferring with the contact end portion 138a so that the ON button 14 can retract to return to its original portion without any interference of the rotating piece 138. In the meantime, when the ON button 14 advances slidably again to rearwardly move the locking bar 60 as shown in FIGS. 16 and 17, the press piece 14b pushes the contact end portion 138a of the rotating piece 138 while being brought into close contact with the contact end portion 138a in a state of being maintaining its own position without any pivotal rotation as being supported by the distal end of the ON button 14. Here, a saw-toothed concavo-convex portion is formed on the contact surfaces of the press piece 14b of the ON button 14 and the contact end portion 138a of the rotating piece 138 so that the press piece 14b can stably engage with the contact end portion 138a.

Next, the OFF unit 110 according to the third preferred embodiment of the present invention includes an OFF button 120 instead of the OFF joint mechanism 130 unlike the OFF units 110 according to the first and second preferred embodiments of the present invention.

Referring to FIGS. 18 and 19, the OFF button 120 is slidably coupled to the housing 12 so that when a user pushes the OFF button 120, the OFF bar 134 operates the opening/closing unit 40 to cause the second opening/closing terminal 44 and the first opening/closing terminal 42 in close contact with the second input terminal 24 and the first input terminal 22, respectively, to be simultaneously separated from the second input terminal 24 and the first input terminal 22, and then the OFF button 120 returns to its original position. Such an OFF button 120 is slidably coupled to the housing 12 in such a fashion as to be elastically moved by means of a spring 124 in the same manner as the ON button 14 as described above. The OFF bar 134 operating the release piece 58 of the opening/closing unit 40 associated with the OFF unit 110 is mounted to the fixed stand 132 securely fixed to the housing 12 in such a fashion as to rotate pivotally in the horizontal direction by means of a pin and a torsion spring, so that when the OFF button 120 advances to push one end of the OFF bar 134 by as shown in FIG. 19(d), the OFF bar 134 rotates pivotally about the fixed stand 132 to cause the other end of the OFF bar 134 to push the release piece 58 so that the release piece 58 presses the second stopper 68 retainingly positioned at one distal end of the second aperture 56 to cause the first stopper 66 of the sub-rod 64 of the locking bar 60 positioned at the second aperture 56 to be released from the second aperture 56 of the supporting barrel 50 in the sliding direction the ON button 14 by an elastic force of the spring 78 supporting the pressing bar 70 so as to be inserted into and retained in the first aperture 54 and cause the second stopper 68 of the sub-rod 64 to be retained at the other distal end of the second aperture 56 of the supporting barrel 50, and then the OFF button 120 retracts to return to its original position (see FIG. 19(a)).

The OFF unit 110 may be configured to selectively use the OFF button 120 and/or the remote module 140.

In the case where the OFF button 120 is included in the OFF unit 110, the ON button 14 and the OFF button 120 may be configured to have a structure such as a typical ON/OFF switch.

Meanwhile, the switch 10 according to the third preferred embodiment of the present invention is configured differently from the switches 10 according to the first and second preferred embodiments of the present invention in that a support block 90 for fixing the second delay bracket 81b constituting the delay unit 80 is mounted on the path along which the ON button 14 slides, and the support block 90 has a hole 92 defined at an upper side thereof so as to allow the ON button to pass therethrough.

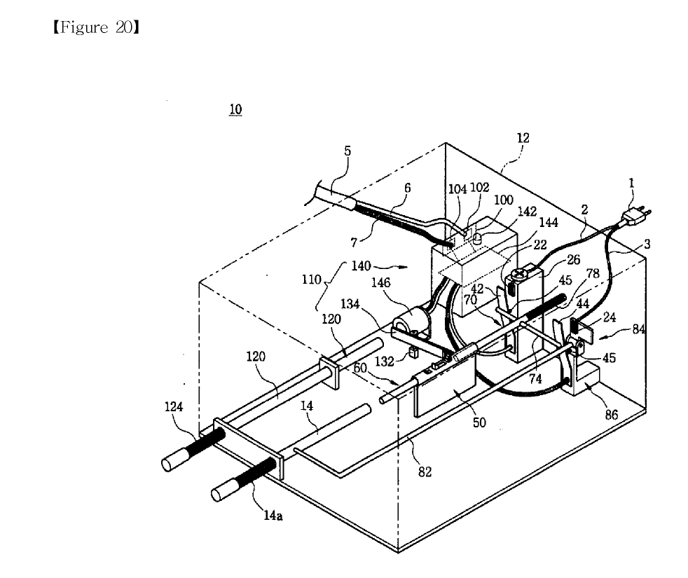

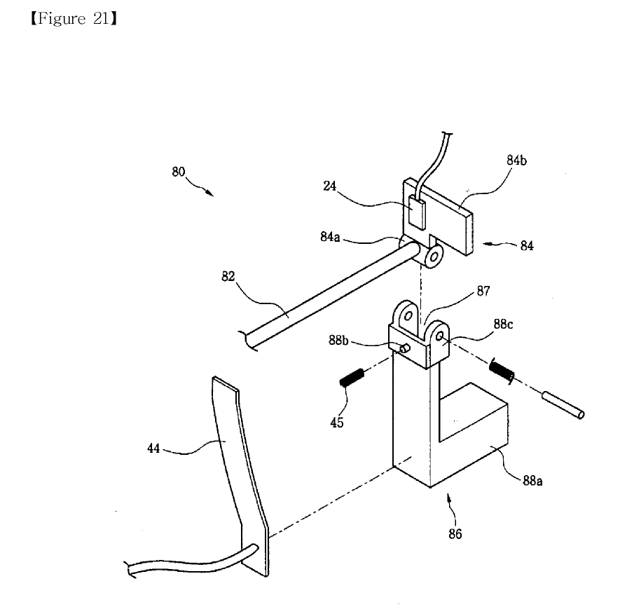

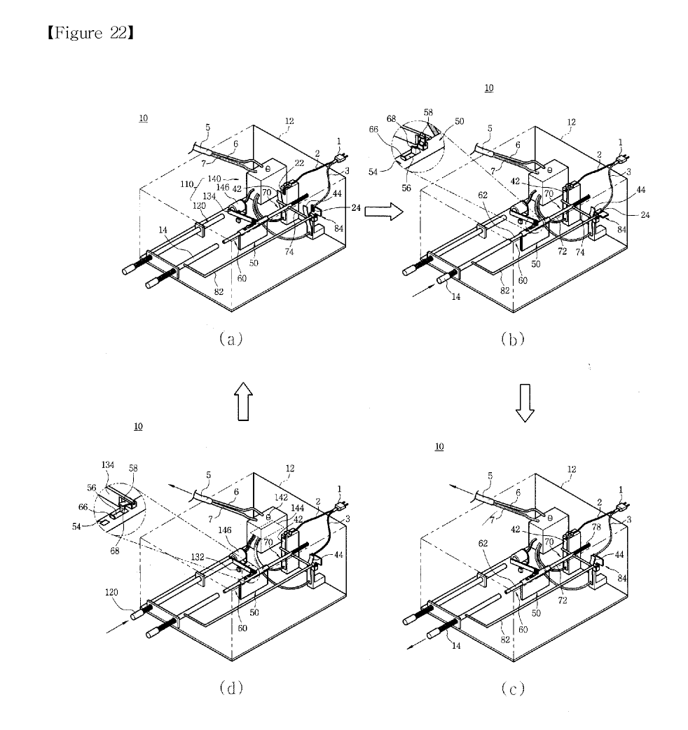

FIG. 20 is a perspective view illustrating the main elements of a standby power cut-off switch according to a fourth preferred embodiment of the present invention, FIG. 21 is an exploded perspective view illustrating a main construction of a delay unit in the standby power cut-off switch of FIG. 20, and FIG. 22 is a perspective views sequentially illustrating an operation mechanism of the standby power cut-off switch of FIG. 20.

The switch 10 according to the fourth preferred embodiment of the present invention includes a housing 12, an ON button 14, an input terminal block 20, an opening/closing unit 40, a delay unit 80, and output terminal block 100 and an OFF unit 110 as in the third preferred embodiment as described above. In this case, since the construction and operation of the switch 10 according to the fourth preferred embodiments of the present invention is the same as that of the aforementioned third preferred embodiment except the delay unit 80, the detailed description thereof will be omitted.

In the fourth preferred embodiment of the present invention, the delay unit 80 includes a support block 86, a delay plate 84 and a delay bar 82 as shown in FIGS. 20 and 21.

The support block 86 is coupled to the housing in such a fashion as to be spaced apart at one side thereof from the housing 12 to define a space, and the second opening/closing terminal 44 is coupled at a lower end thereof to the one side of the support block 86. Also, the delay plate 84 allows the second input terminal 24 to be fixedly coupled thereto and includes a support plate 84b pivotally hinged at a lower side thereof to an upper side of the support block 86 by means of a torsion spring so that after the delay plate 84 rotate pivotally, it returns to its original position by the torsion spring.

The delay bar 82 is integrally coupled at one end thereof to one side of the outer circumferential surface of the ON button 14 and is disposed at the other end thereof adjacent to one end of the delay plate 84 so that when the ON button 14 is pushed to advance, the support plate 84b is pushed to cause the delay plate 84 to rotate pivotally.

As described above, the delay unit 80 is operated such that when the ON button 14 is pushed to advance as shown in FIG. 22(b), the delay bar 82 first pivotally rotates the delay plate 84 to cause the second input terminal 24 and the second output terminal 104 to be electrically disconnected from each other and then the opening/closing unit 40 is operated to bring the first opening/closing terminal 42 and the first input terminal 22 into close contact with each other to cause the first input terminal 22 and the first output terminal 102 to be electrically connected with each other. Then, as shown in FIG. 22(c), when the ON button 14 retracts to return to its original position, the delay plate 84 pivotally rotates to return to its original position by the torsion spring to bring the second input terminal 24 into close contact with the second opening/closing terminal 44 to cause the second input terminal 24 and the second output terminal 104 to be electrically connected with each other.

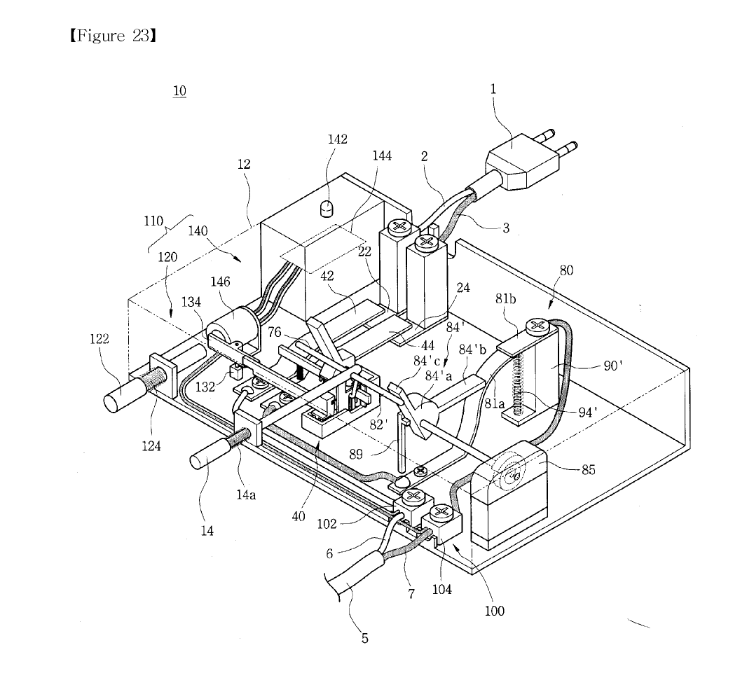

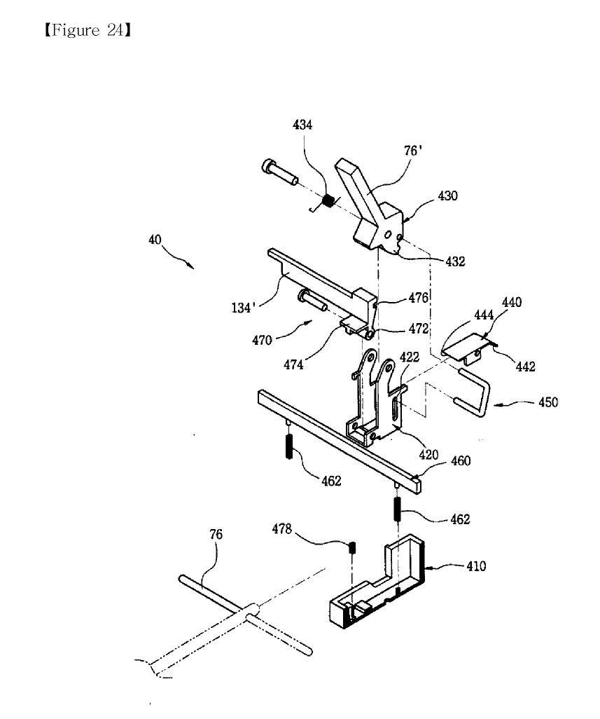

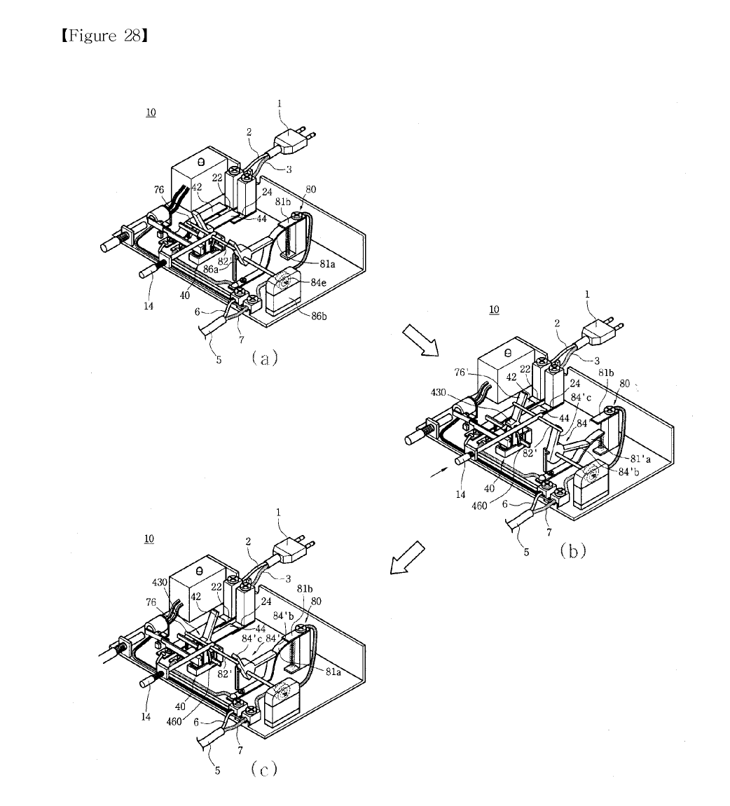

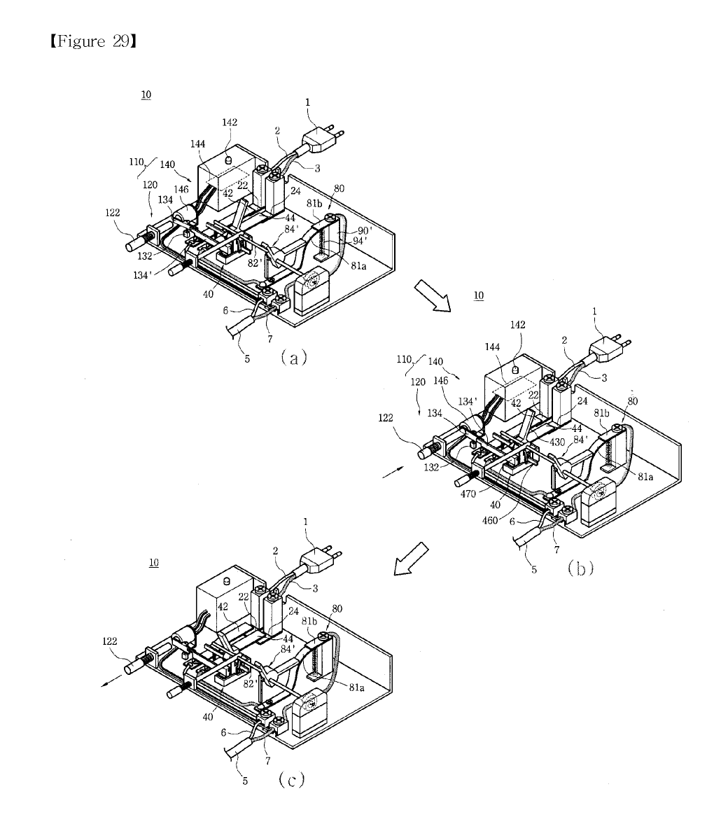

FIG. 23 is a perspective view illustrating the main elements of a standby power cut-off switch according to a fifth preferred embodiment of the present invention, FIGS. 24 to 27 are exploded and assembled perspective views illustrating a main construction of an opening/closing unit in the standby power cut-off switch of FIG. 23, FIG. 28 is a perspective view sequentially illustrating an operation mechanism of turning on the power supply of the standby power cut-off switch of FIG. 23, and FIG. 29 is a perspective view sequentially illustrating an operation mechanism of turning off the power supply of the standby power cut-off switch of FIG. 23.

Referring to FIGS. 23 to 29, a switch 10 according to the fifth preferred embodiment of the present invention is configured such that the terminal switching structure of a switch adopting a double-pole switch generally known based on a technical spirit of the present invention is applied to the opening/closing unit 40. The switch 10 according to the fifth preferred embodiment of the present invention is configured such that the output terminal block 100 is connected with the remote module 140 of the OFF unit 110 and a main body of the electric product by an electric wire. Also, the switch 10 is configured such that the remote module 140 is connected to an internal circuit of the electric product to receive a signal from the internal circuit by means of an electric wire, and is configured of a switch type in which the ON button 14 and the OFF button 120 are mounted to the electric product so as to be operated in cooperation with the opening/closing unit 40 and the delay unit 80.

More specifically, in the switch 10 according to the fifth preferred embodiment of the present invention, the second input terminal 24 and the first input terminal 22 of the input terminal block 20 are mounted to the bottom surface of the housing 12 in such a fashion as to be arranged in parallel with the sliding direction the ON button 14. Also, the second opening/closing terminal 44 and the first opening/closing terminal 42 of the opening/closing unit 40 are arranged in parallel with the sliding direction the ON button 14 in such a fashion such that one end of the second opening/closing terminal 44 is securely fixed to the bottom of the housing 12 and is connected to the first delay bracket 81a by means of an electric wire, one end of the first opening/closing terminal 42 is securely fixed to the bottom of the housing 12 and is connected to the first output terminal 102 by means of an electric wire so as to be electrically connected to the remote module 140 and the inside of the electric product, and the other ends of the second opening/closing terminal 44 and the first opening/closing terminal 42 are spaced apart from the second input terminal 24 and the first input terminal 22 at respective corresponding positions so as to elastically moved so that the second opening/closing terminal 44 and the first opening/closing terminal 42 can be brought into close contact with and separated from the second input terminal 24 and the first input terminal 22.

In the switch 10 according to the fifth preferred embodiment of the present invention, the opening/closing unit 40 includes a pushing bar 76, a support 420, a rotator 430, a hook 440, a release lever 470 and a loader 460. Such a construction is of a type which employs a technical construction applied to a switch typically consisting of a double-pole switch on a basis of the technical spirit of the present invention.

The opening/closing unit 40 will be discussed in detail hereinafter.

The pushing bar 76 is formed protrudingly at one side of the outer circumferential surface of the ON button 14. The support 420 is disposed to correspond to a position where the pushing bar 76 is formed, and is securely fixed to the housing 12 so as to arranged in parallel with the sliding direction of the ON button 14 as shown in FIG. 24. Such a support 420 is fixed a support case 410 formed on the bottom of the housing 12 by means of a bolt (not shown). Such a fixing structure will adopt a variety of forms in the art to which the present invention pertains.

In addition, the rotator 430 is supported by a spring 434 so that after the rotator 430 rotates pivotally, it returns to its original position by the spring, and is hingeably coupled to the support 420. Also, the rotator 430 includes a rotating bar 76′ protrudingly formed thereon so as to rotate pivotally by the forward movement of the ON button 14.

Further, the hook 440 is coupled to the support 420 by means of a connecting pin 450 passing through a lower side of the rotator 430 and slots 422 of the support 420 so as to be operated in cooperation with the rotator 430. The support 420 has slots 422 formed vertically at both sides thereof so as to insert the connecting pin 450 thereto. The hook 440 includes a bent portion 442 formed at a front end thereof so that the hook 440 is pressed by the rotator 430 to cause the bent portion 442 to press the loader 460 positioned below the hook 440. Also, a rear end 444 of the hook 440 is inserted into a release groove 476 of a release piece 134′ so that the actuator 146 of the OFF unit 110 pulls one side of the OFF bar 134 to cause the other side of the OFF bar 134 to push the release piece 134′ so as to release the rear end 444 of the hook 440 inserted into the release groove 476 of the release piece 134′ to cause the rotator 430 to rotate pivotally to return to its original position.

Also, the release lever 470 includes a hinge boss 472 formed at a lower end thereof so as to be hingeably coupled to the support 420, a clearance boss 474 which extends outwardly from the hinge boss 472 in the direction of the OFF button 14 and is supported by a spring 478, and the release piece 134′ extending in the direction of OFF the unit 110 and having the release groove 476 for inserting the rear end 444 of the hook 440 thereto so that when the rotator 430 rotates pivotally, it is held in position. The release lever 470 serves to release the contact states between the second input terminal 24 and the second opening/closing terminal 44 and the first input terminal 22 and the first opening/closing terminal 42 through the operation of the ON button 14 as shown in FIG. 28. That is, in a state where the rotator 430 is retained to be held in position upon the powering on of the electric product as shown in FIG. 28, when the OFF unit 110 is operated as shown in FIG. 29, the release piece 134′ of the release lever 470 is rearwardly moved by the OFF bar 120 of the OFF unit 110, i.e., in a direction opposite to the advancing direction of the ON button 14 to escape the rear end 444 of the hook 440 inserted into the release groove 476 of the release piece 134′ to cause the rotator 430 to be released from its retained state and simultaneously the loader 460 which presses the second opening/closing terminal 44 and the first opening/closing terminal 42 has pressed by receiving a force from the connecting pin 450 to be lifted by an elastic restoring force of the spring 462 so as to return the rotator 430 to its original position.

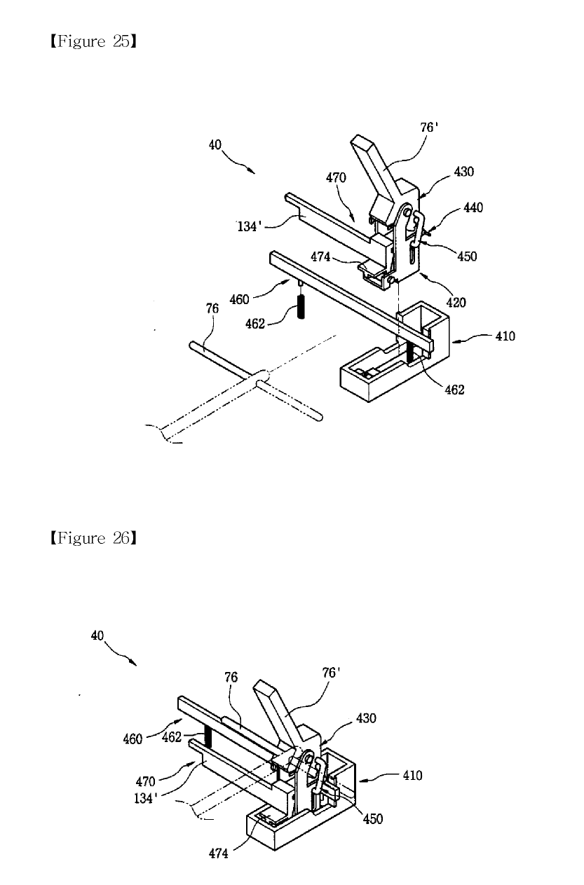

The support 420, the rotator 430, the hook 440 and the release lever 470 are coupled to one another as shown in FIG. 25.

In addition, the loader 460 is positioned above the second opening/closing terminal 44 and the first opening/closing terminal 42 and is supported by the spring 462 so as to be spaced apart from the second opening/closing terminal 44 and the first opening/closing terminal 42. Also, the loader 460 is disposed below the hook 440 so that the loader 460 is pressed by the hook 440 to cause the second opening/closing terminal 44 and the first opening/closing terminal 42 to be simultaneously brought into close contact with the second input terminal 24 and the first input terminal 22.

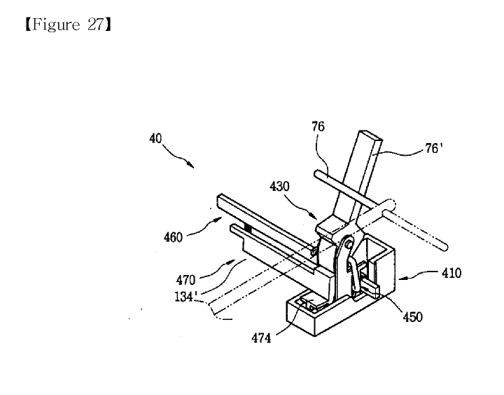

The loader 460 is coupled to the support case formed on the housing 12 together with an assembly of the support 420, the rotator 430, the hook 440 and the release lever 470 as shown in FIG. 26.

Through such a construction, as shown in FIGS. 27 and 28, in the case where the power is applied to the electric product in which the switch 10 according to the fifth preferred embodiment of the present invention, when a user pushes the ON button 14 in a state where the power is turned off (see FIG. 23), the ON button 14 is slidably moved forwardly, i.e., advances slidably with it being supported by the housing 12. In such a process, when the rotating bar 76′ of the rotator 430 is retained by the pushing bar 76 formed on the ON button 14 and then the rotator 430 rotates pivotally, the rear end 444 of the hook 440 is supportedly inserted into the release groove 476 of the release piece 134′ and presses the loader 460 while the bent portion 442 of the hook is pressed downwardly by the connecting pin 450 connected to a protrusion 432 (see FIG. 24) of the rotator 430, so that the second opening/closing terminal 44 and the first opening/closing terminal 42 are brought into close contact with the second input terminal 24 and the first input terminal 22 as shown FIG. 28(b). Then, when the ON button 14 reaches a final position of the pushed operation, the rotator 430 is fixed in position, in which time, the rear end 444 of the hook 440 is fixed in position to the release lever 470. In this case, as the bent portion 442 of the hook 440 is lowered, the connecting pin 450 is upright oriented in a crossing direction to thereby prevent the rotator 430 from rotating. Since the fixing force of the hook 440 by the connecting pin 450 is greater than the rotating force allowing the rotator 430 to return to its original position, although the ON button 14 returns to its original position by the spring 14a (see FIG. 23) after the pushing force of the user is released as shown in FIG. 28(c), the second opening/closing terminal 44 and the first opening/closing terminal 42 continue to be pressed by the loader 460 to cause the second opening/closing terminal 44 and the first opening/closing terminal 42 to be maintained in a state of being in close contact with the second input terminal 24 and the first input terminal 22.

In the meantime, the delay unit 80 of the switch 10 according to the fifth preferred embodiment of the present invention includes a delay bar 82′ a first delay bracket 81a, a support block 90′a second delay bracket 81b and a delay rotator 84′ as shown in FIG. 23, and is disposed opposed to the opening/closing unit 40 with the ON button 14 being positioned between the opening/closing unit 40 and the delay unit 80.

The delay bar 82′ of the delay unit 80 is formed protrudingly at one side of the outer circumferential surface of the ON button 14 in such a fashion as to be disposed opposed to the pushing bar 76. The first delay bracket 81a is mounted in parallel with the sliding direction of the ON button 14 in such a fashion that one end thereof is securely fixed to the housing 12 and connected to the second opening/closing terminal 44 by an electric wire and the other end thereof is supported by a spring 94′ so as to be pressed to be elastically moved upon the pushing of the ON button 14. In this case, the first delay bracket 81a is preferably made in the form of an annular elastic sheet of a conductive metal (for example, copper) material. The support block 90′ is mounted at one end thereof to the housing 12 and is spaced apart at the other end thereof from the housing 12 to define a space. The second delay bracket 81b is coupled to the top side of the support block 90′ so as to come into close contact with the first delay bracket 81a and is electrically connected to the second output terminal 104 and the remote module 140. In this case, the second delay bracket 81b is preferably made in the form of a sheet of a conductive metal (for example, copper) material. Further, the delay rotator 84′ includes a body 84′a, a pushing lug 84′b formed radially protrudingly from a side of the body 84′a so as to press the first delay bracket 81a, and a rotating lug 84′c formed radially protrudingly from a side of the body 84′a so as to be pushed by the delay bar 82′ by the advancing movement of the ON button 14. In this case, one side of a rotating center of the body 84′a of the delay rotator 84′ is rotatably coupled, by a connecting bar, to a spring block 85 supoprtedly mounted to the housing 12 so as to allow the body 84′a to rotate to return to its original position, and the delay rotator 84′ is supported by a supporting bar 89 fixed to the housing 12 at the proximity of the spring block 85. In this case, the spring block 85 preferably includes a spiral spring having elasticity.

The delay unit 80 as constructed above is disposed nearer to the ON button than the opening/closing unit 40 when the ON button 14 is pushed to advance so that the first delay bracket 81a and the second delay bracket 81b are separated (opened) from each other and then the second opening/closing terminal 44 and the first opening/closing terminal 42 are simultaneously brought into close contact with the second input terminal 24 and the first input terminal 22 as shown in FIG. 28(b). Thereafter, the ON button retracts to return to its original position, the body 84′a of the delay rotator 84′ rotates to return to its original position by the spring block 85 to cause the first delay bracket 81a and the second delay bracket 81b to be brought into close contact with each other so that two poles of the switch electrically connected sequentially, but not simultaneously to the power supply line 5 of the main body of the electric product and the remote module 140 as shown in FIG. 28(c).

In the meantime, in the switch 10 according to the fifth preferred embodiment of the present invention, since the construction of the OFF unit 110 and the turning off of the power supply are the same as those of the OFF unit 110 of the switch 10 according to the above-mentioned embodiments as shown in FIG. 29, the detailed description thereof will be omitted.

While the standby power cut-off switch according to the preferred embodiments of the present invention has been described and illustrated in connection with specific exemplary embodiments with reference to the accompanying drawings, it will be readily appreciated by those skilled in the art that it is merely illustrative of the preferred embodiments of the present invention and various modifications and changes can be made thereto within the technical spirit and scope of the present invention.

### MODE FOR INVENTION

To accomplish the above object, according to the present invention, there is provided a standby power cut-off switch adapted to be installed in an electric product for completely interrupting supply of an external power to the electric product through a power plug 1, the standby power cut-off switch comprising: a housing 12 securely fixed to the electric product; an input terminal block 20 including a second input terminal 24 which is connected to a second electric wire 3 of the plug 1 in the housing 12 and a first input terminal 22 which is connected to a first electric wire 2 of the plug 1 in the housing 12; an opening/closing unit 40 disposed in the housing 12, the opening/closing unit including a second opening/closing terminal 44 adapted to be brought into close contact with the second input terminal 24 and a first opening/closing terminal 42 adapted to brought into close contact with the first input terminal 22, so that the second opening/closing terminal 44 and the first opening/closing terminal 42 are brought into close contact with and are separated from the second input terminal 24 and the first input terminal 22, respectively; an ON button slidably coupled to the housing 12 so that when a user presses the On button, the opening/closing unit 40 is operated to cause the second opening/closing terminal 44 and the first opening/closing terminal 42 to be brought into close contact with the second input terminal 24 and the first input terminal 22, respectively, and then the ON button returns to its original position; an output terminal block 100 including a second output terminal 104 which is connected to a second electric wire 7 of an internal power supply line 5 extending to the inside of the electric product in such a fashion as to be electrically connected to the second opening/closing terminal 44 of the opening/closing unit 40 within the housing, and a first output terminal 102 which is connected to a first electric wire 6 of the internal power supply line 5 extending to the inside of the electric product in such a fashion as to be electrically connected to the first opening/closing terminal 42 of the opening/closing unit 40 within the housing; an OFF unit 110 disposed in the housing, the OFF unit being adapted to operate the opening/closing unit 40 in a state where the second opening/closing terminal 44 and the first opening/closing terminal 42 of the opening/closing unit 40 are in close contact with the second input terminal 24 and the first input terminal 22, respectively, so that the second opening/closing terminal 44 and the first opening/closing terminal 42 are simultaneously separated from the second input terminal 24 and the first input terminal 22, respectively; and a delay unit 80 disposed between the second input terminal 24 and the second output terminal 104, the delay unit being configured such that the delay unit is operated earlier than the opening/closing unit 40 upon the depression of the ON button 14, thereby preventing the second input terminal 24 and the second output terminal 104 from being electrically connected to each other despite the operation of the opening/closing unit 40, and such that when the opening/closing unit 40 is operated by the pushing of the ON button 14 to cause the first input terminal 22 and the first output terminal 102 to be electrically connected to each other and then the ON button 14 returns to its original position, the second input terminal 24 and the second output terminal 104 are electrically connected to each other, so that the first output terminal 102 and the second output terminal 104 are sequentially connected to the internal power supply line 5 with a time difference.

In the standby power cut-off switch according to the present invention, the second input terminal 24 and the first input terminal 22 of the input terminal block 20 are arranged perpendicularly to a sliding direction of the ON button 14, and the second opening/closing terminal 44 and the first opening/closing terminal 42 of the opening/closing unit 40 are arranged perpendicularly to the sliding direction of the ON button 14 in such a fashion that one end of the second opening/closing terminal 44 is fixed so as to be electrically connected to the second output terminal 104 and the other end of the second opening/closing terminal 44 is spaced apart from the second input terminal 24 at a position corresponding to the second input terminal 24 so as to be elastically movable to be brought into close contact with and separated (opened) from the second input terminal 24, and the one end of the first opening/closing terminal 42 is fixed so as to be electrically connected to the first output terminal 102 and the other end of the first opening/closing terminal 42 is spaced apart from the first input terminal 22 at a position corresponding to the first input terminal 22 so as to be elastically movable to be brought into close contact with and separated (opened) from the first input terminal 22, wherein the opening/closing unit 40 includes: a supporting barrel 50 having a hollow portion 53 opened at front and rear ends thereof and supportedly fixed to the housing 12 in such a fashion that the hollow portion 53 thereof is arranged in parallel with a sliding direction of the ON button 14, the hollow portion 53 having a first aperture 54 and a second aperture 56 formed penetratingly on the outer circumference thereof in such a fashion as to be arranged in parallel with each other; a locking bar 60 including a main rod 62 and a sub-rod 64 branched off from the main rod 62 so as to be elastically moved, so that the main rod and the sub-rod are slidably coupled to the hollow portion 53 of the supporting barrel 50 in a direction where the ON button is oriented, the sub-rod 64 having a first stopper 66 and a second stopper 68 protrudingly formed on the top surface thereof so that when the locking bar 60 is coupled to the supporting barrel 50, the first stopper 66 and the second stopper 68 engage with the first aperture 54 and the second aperture 56, respectively, and when the ON button 14 is pushed, the first stopper 66 and the second stopper 68 engage with the second aperture 56 together so as to be held in position; and a pressing bar 70 including a column 72 and a loader 74 extending outwardly from one side of the column 72 in such a fashion as to be oriented perpendicular to the column 72 so as to press one sides of the second opening/closing terminal 44 and the first opening/closing terminal 42 with a uniform force, the pressing bar 70 being sildably coupled at one end thereof to the hollow portion 53 of the supporting barrel 50 so as to be opposed to the locking bar 60 and being supported at the other end thereof by a spring 78 supportedly mounted to the housing 12, wherein the supporting barrel 50 includes a release piece 58 hingeably mounted on the outer circumferential surface of the hollow portion so as to be positioned adjacent to the second aperture 56, the release piece 58 having a spring mounted therein so that the release piece 58 presses the second stopper 68 of the first and second stoppers 66 and 68 engagedly retained in the second aperture 56 to retract the locking bar 60 to cause the first stopper 66 of the sub-rod 64 to be engagedly retained in the first aperture 54, and then rotates hingeably so as to return to its original position, wherein the delay unit includes a first delay bracket 81a disposed between the supporting barrel 50 and the ON button 14 in such a fashion as to be oriented horizontal to the sliding direction of the ON button 14, a support block 90 disposed between the first delay bracket 81a and the supporting barrel 50 in such a fashion as to be securely fixed to the housing 12, and a second delay bracket 81b joined to the top end of the support block 90 so as to abut against the first delay bracket 81a and electrically connected to the second output terminal 104, and wherein the first delay bracket 81a is fixed to the housing 12 and connected to the second opening/closing terminal 44 by an electric wire at one end thereof and is brought in close contact with the second delay bracket 81b at the other end thereof so that the other end of the first delay bracket 81a is pressed and elastically moved upon the pushing of the ON button 14 so as to be separated from the second delay bracket 81b, whereby when the ON button 14 is pushed and slidably advances, the first delay bracket 81a and the second delay bracket 81b in close contact with each other are first separated from each other, and the opening/closing unit 40 is operated in a state where the second output terminal 104 and the second input terminal 24 are electrically separated from each other to cause the second opening/closing terminal 44 and the first opening/closing terminal 42 to be brought into close contact with the second input terminal 24 and the first input terminal 22, respectively, so as to electrically interconnect the first output terminal 102 and the first input terminal 22, and then when the ON button 14 slidably retracts in an opposite direction to the sliding direction thereof so as to return to its original position, the first delay bracket 81a and the second delay bracket 81b being separated from each other are brought into close contact with each other to cause so as to electrically interconnect the second output terminal 104 and the second input terminal 24.

In the standby power cut-off switch according to the present invention, the OFF unit comprises an OFF joint mechanism 130 which is installed at a position spaced apart from a path along which the ON button 14 slides, and a rotating piece 138 formed at one side end thereof is positioned on the sliding path of the ON button 14 in response to the forward and rearward sliding movement or the slidable advancing and retracting movement of one cycle of the ON button 14 and the advancing movement of the locking bar 60 so that the rotating piece 138 is pushed by the ON button 14 to cause the other side end of the OFF joint mechanism 130 to push one side of an OFF bar 134 to allow the other side of the OFF bar 134 to operate the opening/closing unit 40 to thereby allow the second opening/closing unit 44 and the second opening/closing unit 42 in close contact with the second input terminal 24 and the first input terminal 22 to be simultaneously separated from the second input terminal 24 and the first input terminal 22.

In the standby power cut-off switch according to the present invention, the OFF joint mechanism 130 comprises: a pair of supports 133 and 133′ installed beside one side of the opening/closing unit 40 in such a fashion as to be spaced apart from each other, the supports having support holes 133a and 133a′ penetratingly formed at the upper ends thereof, respectively; a movable member 136 including a body portion 136b formed in a bar shape, a connecting portion 136a and a press portion 136c formed protrudingly vertically from both ends of the body portion 136b in such a fashion as to oriented in opposite directions, respectively, the movable member 136 being supported by the supports 133 and 133′ such that the press portion 136c and the connecting portion 136a are penetratingly inserted into the support holes 133a and 133a′ of the supports 133 and 133′ so as to be moved in a horizontal direction and being given an elastic restoring force by means of a spring interposed between the support 133 and the body portion 136b so as to allow the press portion 136c to be fit thereto; the rotating piece 138 formed in a “ [symbol] ” shape which is bent at one end thereof to one side to form a contact end portion 138a and is coupled at the other end thereof to the connecting portion 136a of the movable member 136 by means of a pin so that when the rotating piece 138 can rotate pivotally, the contact end portion 138a is positioned on the sliding path of the ON button 14; and the OFF bar 134 adapted to be horizontally pivotally inserted at a central portion thereof to a rotary shaft 132a formed upright on a fixed stand 132 fixedly mounted to the housing 12 such that when the ON button 14 advances, one end of the OFF bar 134 is pushed by the pressing portion 136c of the movable member 136 to cause the other end of the OFF bar 134 to push the release piece 58 of the opening/closing unit 40 to retract the locking bar 60 in a direction opposite to the slidable advancing direction of the locking bar 60, wherein the locking bar of the opening/closing unit 40 has a retaining jaw 60a formed laterally protrudingly at a distal end thereof, wherein the rotating piece 138 is pin-coupled to the connecting portion 136a in such a fashion that a tip of the other end thereof protrudes externally from the connecting portion 136a by a predetermined length, and wherein a torsion spring is mounted between the rotating piece 138 and the connecting portion 136a to impart elasticity to the rotating piece 138 so that the contact end portion 138a of the rotating piece 138 stays at a position spaced apart from the sliding path of the ON button 14 by means of elasticity of the torsion spring as the locking bar 60 retracts in response to the sliding movement of the ON button 14, and the contact end portion 138a of the rotating piece 138 is positioned on the sliding path of the ON button 14 by means of pivotal rotation of the rotating piece 138 as the externally protruding tip of the other end of the rotating piece 138 is pushed by the retaining jaw 60a of the locking bar 60 advancing in response to the sliding movement of the ON button 14.

In the standby power cut-off switch according to the present invention, the rotating piece 138 according to the present invention is formed by separately pin-coupling the contact end portion 138a as one end thereof to the other end thereof. In this case, the rotating piece 138 includes a “ [symbol] ”-shaped stopper 138b formed at the other end thereof and a compression spring 138c mounted between the contact end portion 138a and the other end thereof, so that the contact end portion 138a rotates pivotally to prevent the ON button 14 and the contact end portion 138a from interfering each other during the slidable forward movement of the ON button 14 for advancing the locking bar 60 and the rotating piece 138 is held in position to maintain a “ [symbol] ” shape during the slidable rearward movement of the ON button 14 for retracting the locking bar 60 to cause the contact end portion 138a to be positioned on the sliding path of the ON button 14.

In the standby power cut-off switch according to the present invention, the rotating piece 138 is configured such that the contact end portion 138a as one end thereof and the other end thereof are integrally formed with each other to constitute a single rotating piece. The ON button includes a press piece 14b coupled to a distal end thereof by means of a torsion spring and a pin so that the press piece 14b pushes the contact end portion 138a of the rotating piece 138 while being brought into close contact with the contact end portion 138a. Here, a saw-toothed concavo-convex portion is formed on the contact surfaces of the press piece 14b of the ON button 14 and the contact end portion 138a of the rotating piece 138 so that the press piece 14b can stably engage with the contact end portion 138a.

In the standby power cut-off switch according to the present invention, the OFF button 120 is slidably coupled to the housing 12 so that when a user pushes the OFF button 120, it pushes one side of the OFF bar 134 and the other side of the OFF bar 134 operates the opening/closing unit 40 to cause the second opening/closing terminal 44 and the first opening/closing terminal 42 in close contact with the second input terminal 24 and the first input terminal 22, respectively, to be simultaneously separated from the second input terminal 24 and the first input terminal 22, and then the OFF button 120 returns to its original position.

In the standby power cut-off switch according to the present invention, the OFF unit 110 includes a controller 144 operated by receiving the power applied to the inside of the switch through the operation of the opening/closing unit 40 and the delay unit 80 so as to perform a wireless remote control, a sensor 142 connected to the controller 144 for receiving a wireless remote control signal, and an actuator 146 adapted to pull one side of the OFF bar 134 to allow the other side of the OFF bar 134 to operate the opening/closing unit 40 under the control of the controller 144 electrically connected to an internal circuit of the electric product for receiving a signal command from the internal circuit of the electric product to cause the second and first opening/closing terminals 44 and 42 in close contact with the second and first input terminals 24 and 22 to be simultaneously separated from the second and first input terminals 24 and 22.

Meanwhile, in the standby power cut-off switch according to the present invention, the delay unit 80 includes a support block 86 which is spaced apart at one side thereof from the housing 12 to define a space and to which the second opening/closing terminal 44 is coupled, a delay plate 84 to which the second input terminal 24 is fixedly coupled and which includes a support plate 84b pivotally hinged at a lower side thereof to an upper side of the support block 86 by means of a spring so that after the delay plate 84 rotate pivotally, it returns to its original position by the spring, and a delay bar 82 which is coupled at one end thereof to one side of the outer circumferential surface of the ON button 14 in such a fashion as to perpendicularly extend from the outer circumferential surface of the ON button 14 and bent at right angle to be arranged in parallel with the ON button 14 and is disposed at the other end thereof adjacent to one end of the delay plate 84 so that when the ON button 14 is pushed to advance, the delay plate 84 first rotates pivotally so as to allow the second output terminal 104 and the second input terminal 24 to be electrically disconnected from each other and then the opening/closing unit 40 is operated so as to allow the first opening/closing terminal 42 to be brought into close contact with the first input terminal 22 to electrically interconnect the first output terminal 102 and the first input terminal 22, and then when the ON button 14 retracts to return to its original position, the delay plate 84 rotates pivotally to return to its original position to bring the second opening/closing terminal 44 and the second input terminal 24 into close contact with each other so as to allow the second output terminal 104 and the second input terminal 24 to be electrically connected to each other.

### INDUSTRIAL APPLICABILITY

The present invention relates to a standby power cut-off switch, and more particularly, to such a standby power cut-off switch which is directly installed in electric products such as TV sets, audio systems, computers, etc., so that even when a power plug is connected to an electrical outlet, supply of an external power to the electric products through the plug is completely interrupted (i.e., double pole interruption) mechanically by means of an automatically controlled OFF signal so as to prevent the consumption of standby power, and in which first input terminal and a first output terminal are first electrically connected to each other and then a second input terminal and a second output terminal are electrically connected to each other so that a double-pole switch eventually functions as a single-pole switch so as to allow an electrical contact between terminals to be made sequentially, thereby preventing a spark and an electrical shock to the electric product that may occur when the two poles of the switch concurrently come into close contact with a main body of the electric product during the powering on of the electric products.

1. A standby power cut-off switch adapted to be installed in an electric product for completely interrupting supply of an external power to the electric product through a power plug 1 during the powering off of the electric product, the standby power cut-off switch comprising:
a housing 12 securely fixed to the electric product;
an input terminal block 20 including a second input terminal 24 which is connected to a second electric wire 3 of the plug 1 within the housing 12 and a first input terminal 22 which is connected to a first electric wire 2 of the plug 1 within the housing 12;
an opening/closing unit 40 disposed in the housing 12, the opening/closing unit including a second opening/closing terminal 44 adapted to be brought into close contact with the second input terminal 24 and a first opening/closing terminal 42 adapted to brought into close contact with the first input terminal 22, so that the second opening/closing terminal 44 and the first opening/closing terminal 42 are brought into close contact with and are separated from the second input terminal 24 and the first input terminal 22, respectively;
an ON button slidably coupled to the housing 12 so that when a user presses the On button, the opening/closing unit 40 is operated to cause the second opening/closing terminal 44 and the first opening/closing terminal 42 to be brought into close contact with the second input terminal 24 and the first input terminal 22, respectively, and then the ON button returns to its original position;
an output terminal block 100 including a second output terminal 104 which is connected to a second electric wire 7 of an internal power supply line 5 extending to the inside of the electric product in such a fashion as to be electrically connected to the second opening/closing terminal 44 of the opening/closing unit 40 within the housing, and a first output terminal 102 which is connected to a first electric wire 6 of the internal power supply line 5 extending to the inside of the electric product in such a fashion as to be electrically connected to the first opening/closing terminal 42 of the opening/closing unit 40 within the housing;
an OFF unit 110 disposed in the housing, the OFF unit being adapted to operate the opening/closing unit 40 in a state where the second opening/closing terminal 44 and the first opening/closing terminal 42 of the opening/closing unit 40 are in close contact with the second input terminal 24 and the first input terminal 22, respectively, so that the second opening/closing terminal 44 and the first opening/closing terminal 42 are simultaneously separated from the second input terminal 24 and the first input terminal 22, respectively; and
a delay unit 80 disposed between the second input terminal 24 and the second output terminal 104, the delay unit being configured such that the delay unit is operated earlier than the opening/closing unit 40 upon the depression of the ON button 14, thereby preventing the second input terminal 24 and the second output terminal 104 from being electrically connected to each other despite the operation of the opening/closing unit 40, and such that when the opening/closing unit 40 is operated by the pushing of the ON button 14 to cause the first input terminal 22 and the first output terminal 102 to be electrically connected to each other and then the ON button 14 returns to its original position, the second input terminal 24 and the second output terminal 104 are electrically connected to each other, so that the first output terminal 102 and the second output terminal 104 are sequentially connected to the internal power supply line 5 with a time difference.

2. The standby power cut-off switch according to claim 1, wherein the second input terminal 24 and the first input terminal 22 of the input terminal block 20 are arranged perpendicularly to a sliding direction of the ON button 14, and the second opening/closing terminal 44 and the first opening/closing terminal 42 of the opening/closing unit 40 are arranged perpendicularly to the sliding direction of the ON button 14 in such a fashion that one end of the second opening/closing terminal 44 is fixed so as to be electrically connected to the second output terminal 104 and the other end of the second opening/closing terminal 44 is spaced apart from the second input terminal 24 at a position corresponding to the second input terminal 24 so as to be elastically movable to be brought into close contact with and separated (opened) from the second input terminal 24, and the one end of the first opening/closing terminal 42 is fixed so as to be electrically connected to the first output terminal 102 and the other end of the first opening/closing terminal 42 is spaced apart from the first input terminal 22 at a position corresponding to the first input terminal 22 so as to be elastically movable to be brought into close contact with and separated (opened) from input terminal 22,
wherein the opening/closing unit 40 includes:
a supporting barrel 50 having a hollow portion 53 opened at front and rear ends thereof and supportedly fixed to the housing 12 in such a fashion that the hollow portion 53 thereof is arranged in parallel with a sliding direction of the ON button 14, the hollow portion 53 having a first aperture 54 and a second aperture 56 formed penetratingly on the outer circumference thereof in such a fashion as to be arranged in parallel with each other;
a locking bar 60 including a main rod 62 and a sub-rod 64 branched off from the main rod 62 so as to be elastically moved, so that the main rod and the sub-rod are slidably coupled to the hollow portion 53 of the supporting barrel 50 in a direction where the ON button is oriented, the sub-rod having a first stopper 66 and a second stopper 68 protrudingly formed on the top surface thereof so that when the locking bar 60 is coupled to the supporting barrel 50, the first stopper 66 and the second stopper 68 engage with the first aperture 54 and the second aperture 56, respectively, and when the ON button 14 is pushed, the first stopper 66 and the second stopper 68 engage with the second aperture 56 together so as to be held in position; and
a pressing bar 70 including a column 72 and a loader 74 extending outwardly from one side of the column 72 in such a fashion as to be oriented perpendicular to the column 72 so as to press one sides of the second opening/closing terminal 44 and the first opening/closing terminal 42 with a uniform force, the pressing bar 70 being sildably coupled at one end thereof to the hollow portion 53 of the supporting barrel 50 so as to be opposed to the locking bar 60 and being supported at the other end thereof by a spring 78 supportedly mounted to the housing 12,
wherein the supporting barrel 50 includes a release piece 58 hingeably mounted on the outer circumferential surface of the hollow portion so as to be positioned adjacent to the second aperture 56, the release piece 58 having a spring mounted therein so that the release piece 58 presses the second stopper 68 of the first and second stoppers 66 and 68 engagedly retained in the second aperture 56 to retract the the locking bar 60 to cause the first stopper 66 of the sub-rod 64 to be engagedly retained in the first aperture 54, and then rotates hingeably so as to return to its original position, and wherein the delay unit includes a first delay bracket 81a disposed between the supporting barrel 50 and the ON button 14 in such a fashion as to be oriented horizontal to the sliding direction of the ON button 14, a support block 90 disposed between the first delay bracket 81a and the supporting barrel 50 in such a fashion as to be securely fixed to the housing 12, and a second delay bracket 81b joined to the top end of the support block 90 so as to abut against the first delay bracket 81a and electrically connected to the second output terminal 104, wherein the first delay bracket 81a is fixed to the housing 12 and connected to the second opening/closing terminal 44 by an electric wire at one end thereof and is brought in close contact with the second delay bracket 81b at the other end thereof so that the other end of the first delay bracket 81a is pressed and elastically moved upon the pushing of the ON button 14 so as to be separated from the second delay bracket 81b,
whereby when the ON button 14 is pushed and slidably advances, the first delay bracket 81a and the second delay bracket 81b in close contact with each other are first separated from each other, and the opening/closing unit 40 is operated in a state where the second output terminal 104 and the second input terminal 24 are separated from each other to cause the second opening/closing terminal 44 and the first opening/closing terminal 42 to be brought into close contact with the second input terminal 24 and the first input terminal 22, respectively, so as to electrically interconnect the first output terminal 102 and the first input terminal 22, and then when the ON button 14 slidably retracts in an opposite direction to the sliding direction thereof so as to return to its original position, the first delay bracket 81a and the second delay bracket 81b being separated from each other are brought into close contact with each other to cause so as to electrically interconnect the second output terminal 104 and the second input terminal 24.

3. The standby power cut-off switch according to claim 2, wherein the OFF unit comprises an OFF joint mechanism 130 which is installed at a position spaced apart from a path along which the ON button 14 slides, and a rotating piece 138 formed at one side end thereof is positioned on the sliding path of the ON button 14 in response to the forward and rearward sliding movement or the slidable advancing and retracting movement of one cycle of the ON button 14 and the advancing movement of the locking bar 60 so that the rotating piece is pushed by the ON button 14 to cause the other side end of the OFF joint mechanism to push one side of an OFF bar to allow the other side of the OFF bar to operate the opening/closing unit 40 to thereby allow the second opening/closing unit 44 and the second opening/closing unit 42 in close contact with the second input terminal 24 and the first input terminal 22 to be simultaneously separated from the second input terminal 24 and the first input terminal 22.

4. The standby power cut-off switch according to claim 3, wherein the OFF joint mechanism 130 comprises:
a pair of supports 133 and 133′ installed at one side of the opening/closing unit 40 in such a fashion as to be spaced apart from each other, the supports having support holes 133a and 133a′ penetratingly formed at the upper ends thereof, respectively;
a movable member 136 including a body portion 136b formed in a bar shape, a connecting portion 136a and a press portion 136c formed protrudingly vertically from both ends of the body portion 136b in such a fashion as to oriented in opposite directions, respectively, the movable member 136 being supported by the supports 133 and 133′ such that the press portion 136c and the connecting portion 136a are penetratingly inserted into the support holes 133a and 133a′ of the supports 133 and 133′ so as to be moved in a horizontal direction and being given an elastic restoring force by means of a spring interposed between the support 133a and the body portion 136b so as to allow the press portion 136c to be fit thereto;
the rotating piece 138 formed in a “ [symbol] ” shape which is bent at one end thereof to one side to form a contact end portion 138a and is coupled at the other end thereof to the connecting portion 136a of the movable member 136 by means of a pin so that when the rotating piece 138 can rotate pivotally, the contact end portion 138a is positioned on the sliding path of the ON button 14; and
the OFF bar 134 adapted to be horizontally pivotally inserted at a central portion thereof to a rotary shaft 132a formed upright on a fixed stand 132 fixedly mounted to the housing 12 such that when the ON button 14 advances, one end of the OFF bar 134 is pushed by the pressing portion 136c of the movable member 136 to cause the other end of the OFF bar 134 to push the release piece 58 of the opening/closing unit 40 to retract the locking bar 60 in a direction opposite to the slidable advancing direction of the locking bar 60,
wherein the locking bar of the opening/closing unit 40 has a retaining jaw 60a formed laterally protrudingly at a distal end thereof,
wherein the rotating piece 138 is pin-coupled to the connecting portion 136a in such a fashion that a tip of the other end thereof protrudes externally from the connecting portion 136a by a predetermined length, and
wherein a torsion spring is mounted between the rotating piece 138 and the connecting portion 136a to impart elasticity to the rotating piece 138 so that the contact end portion 138a of the rotating piece 138 stays at a position spaced apart from the sliding path of the ON button 14 by means of elasticity of the torsion spring as the locking bar 60 retracts in response to the sliding movement of the ON button 14, and the contact end portion 138a of the rotating piece 138 is positioned on the sliding path of the ON button 14 by means of pivotal rotation of the rotating piece 138 as the externally protruding tip of the other end of the rotating piece 138 is pushed by the retaining jaw 60a of the locking bar 60 advancing in response to the sliding movement of the ON button 14.
